(19) United States
(12) Patent Application Publication
(10) Pub. No.: US 2010/0191598 A1
(43) Pub. Date: Jul. 29, 2010

(54) Automated Multimedia Gateway For Consumer-Controlled Specification, Filtering And Delivery Of Personalized Product/Service Offers

(76) Inventors: Roger Leon TOENNIS, Arvada, CO (US); Alexander John MONTOYA, Westminster, CO (US); Jeffrey LAZERUS, Arvada, CO (US)

Correspondence Address: HOLME ROBERTS & OWEN, LLP, 299 SOUTH MAIN, SUITE 1800, SALT LAKE CITY, UT, 84111, US

(21) Appl. No.: 12/715,232

(22) Filed: Mar. 1, 2010

Related U.S. Application Data
(63) Continuation-in-part of application No. 12/456,994, filed on Jun. 25, 2009.
(60) Provisional application No. 61/156,137, filed on Feb. 27, 2009.
(60) Provisional application No. 61/075,683, filed on Jun. 25, 2008.

(51) Int. Cl. G06Q 30/00; G06Q 99/00

(52) U.S. Cl. 705/14.36; 705/14.61; 705/14.66

(57) ABSTRACT

The present invention relates to systems and methods for consumer-controlled specification, filtering and delivery of multimedia product/service offerings to “opted-in” consumers. A plurality of business subscribers is associated with a plurality of offers, wherein each offer is associated with an offer category. Through a consumer gateway, a consumer member defines a set of consumer preferences that is stored in a consumer profile, wherein the preferences define one or more offer categories preferred by the consumer member. The consumer member selects a set of business subscriber sponsors from the plurality of business subscribers. A set of sponsored offers is defined, each of which originates from the set of business subscriber sponsors. Using consumer preferences, an offer exchange matches a sponsored offer, or offers, to each consumer subscriber from the set of all sponsored offers. A distribution server distributes the sponsored offer or offers to each consumer member according to user preference.

### CROSS REFERENCE TO RELATED APPLICATIONS

The present application claims priority to and the benefit of U.S. Provisional Application No. 61/156,137 to Toennis, entitled “System and Method for Consumer Controlled Delivery of Multimedia Advertising,” filed on Feb. 27, 2009, which is herein incorporated by reference in its entirety. Also, the present application is a continuation-in-part of and claims priority to and the benefit of U.S. patent application Ser. No. 12/456,994 to Toennis, entitled “System and Method for Generating a Consumer-Controlled Marketing and Advertising Ecosystem,” filed Jun. 25, 2009, which claims priority to and the benefit of U.S. Provisional Application No. 61/075,683 to Toennis, entitled “System and Method for Generating a Consumer-Controlled, Marketing and Advertising Ecosystem,” filed Jun. 25, 2008, both of which are herein incorporated by reference in their entirety.

### BACKGROUND OF THE INVENTION

1. Field of the Invention

The one or more present inventions relate to the field of real-time, permission-based marketing and advertising. More specifically, the one or more present inventions relates to a system and method for automatic delivery of customized product/service offerings to “opted-in” consumer recipients who have configured personal preferences for the content, timing, frequency and delivery method for every offering delivered by embodiments of the invention.

2. The Relevant Technology

All businesses face the challenge of delivering relevant, timely and positively viewed marketing messages to their targeted consumers resulting in measurable and profitable increases in consumer buying activities. The entire range of today's “state-of-the-art” marketing, advertising methods and technologies is based on the concept of those businesses, most often with support from contracted third-party vendors to these businesses, being in complete control over the quantity, quality and timing of the marketing impressions that get delivered to targeted consumers. The goal of the businesses, in a contracted and marketing relationship with service vendors, is to optimally refine the content, quality, quantity and timing of the marketing and advertising messages (e.g., campaigns) so as to increase the relevance of marketing/advertising messages to a degree where a sufficient number of undecided and currently non-consuming receivers of the message are motivated by marketing messages to make a purchase of a product or service. Sufficiency is defined by comparing the total costs for a marketing/advertising campaign with the profit generated by the number of sales that resulted as a direct response to the marketing campaign. Unfortunately, despite the investment of massive amounts of time, money, and research that has been focused on developing effective means to achieve attractive and profitable success in these business-controlled marketing campaigns, the marketing and advertising industry continues to fail at providing methods and systems returning measurable and attractive responses to marketing and advertising investments made by businesses.

As an illustration, response rates to direct mail marketing campaigns of one percent (1%) are considered average, and response rates reaching three percent (3%) are considered to be very good. Because of this low level of effectiveness, and because consumers generally have a negative view of poorly targeted advertising, this method of mass marketing/advertising is widely referred to as “junk mail.” In a case where this method of advertising is delivered via electronic mail (email) it is widely and negatively referred to as “spam.” This spam phenomenon is now expanding aggressively onto the contact pages of the World Wide Web (“WWW”). More and more pages of content on the web are being filled up with advertising clutter in an attempt to pay for online services by charging the advertisers for “clicks.” The increasingly aggressive nature of these web-based advertising elements is resulting in consumer information overload that has consumers actively ignoring web-based advertising. This information overload problem erodes response rates (e.g., email replies, call-backs, clicks, click-throughs, etc.) in all these mediums. This effectively decreases the traditional 1%-3% response rates that are already unimpressive.

In 2007, over $160 billion was spent in the United States alone on the combination of direct mail printing, and direct mail consulting and design services in support of delivering paper-based direct mail/junk mail products. By 2010, projections have estimated this number increasing to approximately $200 billion. These billions spent on junk mail each year result in every American receiving approximately seventeen (17) trees-worth of direct mail per year, with most of it ending up in the trash. In total, it takes 100 million trees and 28 billion gallons of water to produce this volume of junk mail. In addition to the wood products and water, the direct mail industry uses massive quantities of electricity, ink and a range of toxic chemicals to produce the yearly output of direct mail. All of this adds up to a massive and negative environmental impact.

As discussed above, these traditional business-controlled approaches to advertising and marketing have proven themselves to be fundamentally flawed as an approach to meeting the business challenge. Despite the massive investment made each year, the business-controlled approach continually fails to produce useful business results and, instead, contributes a massive amount of paper and chemical waste that negatively impacts the environment. In addition, these continuing failures have engendered a skepticism and negative impression of advertising and marketing, both in the business community and virtually the entire general public. Therefore, the below disclosed subject matter is directed to solve this unsolved problem.

### SUMMARY OF THE INVENTION

A system and method for automatic delivery of consumer-controlled product/service offerings to “opted-in” consumer recipients (“members”) who have configured personal preferences for the content, timing, frequency and delivery method for every offering delivered to them via embodiments of the present invention. Accordingly, one or more systems and/or methods for providing consumer-controlled product/service offerings to “opted-in” consumers are described herein.

One embodiment comprises a system that includes, among other things, a consumer (who has subscribed, “opted-in”, to a subscription service to receive personalized product/service offers), a business subscriber (a business looking for consumers that desire the business' services or goods), a data analytic server (to monitor statistics such as rates of response), a multimedia (audio, video, text, etc) management server (to provide for the creation and management of recorded multimedia offer messages), a distribution server (to manage any multimedia information sent out), the Internet, a telephone and/or data/cellular networking system, and a recipient device for the consumer to access the content of the recorded offer messages.

In addition, a consumer gateway for consumer-controlled marketing is described in another embodiment of the present invention. A plurality of business subscribers is associated with a plurality of offers, wherein each offer is associated with an offer category. A consumer member who has subscribed to the consumer gateway defines a set of consumer preferences that are stored in a consumer profile, wherein the set of consumer preferences defines one or more offer categories preferred by the consumer member. The consumer member selects a set of business subscriber sponsors from the plurality of business subscribers. A set of sponsored offers is defined, each of which originates from the set of business subscriber sponsors. An offer exchange matches a sponsored offer from the set of sponsored offers with the consumer member based on the set of preferences. A distribution server distributes the sponsored offer to the consumer member according to the preset consumer preferences.

A method for consumer-controlled distribution of marketing is disclosed, in another embodiment of the present invention. The method includes determining a set of consumer preferences as defined by a consumer member of a system that provides for consumer-controlled marketing. One or more offer categories are determined, where the consumer member based on the set of preferences prefers the offer categories. A plurality of offers is received from a plurality of business subscribers, each of which subscribes to the system that provides for consumer-controlled marketing. Each of the plurality of offers is associated with an offer category, previously mentioned. A set of business subscriber sponsors is determined, each of which is selected from the plurality of business subscribes by the consumer member. The plurality of offers is reduced by determining a set of sponsored offers, each of which originate from or is associated with one of the set of business subscriber sponsors. The set of sponsored offers is further reduced by matching by category a sponsored offer from the set of sponsored offers with the consumer member, or more particularly with the categories preferred by the consumer member, based on the set of consumer preferences. The sponsored offer is distributed to the consumer member over one or a plurality of communication networks.

At least one embodiment described herein also comprises a method and/or system for analyzing and/or tracking data including, but not limited to, the number of responses to advertising, the number of messages that have been forwarded to other members of the consumer's social network, and the timing of such responses.

A method for consumer-controlled redistribution (“forwarding”) of product/service offers that have been received by a consumer is disclosed in another embodiment of the present invention. The method includes allowing consumer subscribers to the consumer gateway to manually forward product/service offers they receive to friends/colleagues or other contacts in their social network. The method allows subscribed consumers to configure a plurality of lists on the gateway of personal friends and/or colleagues. Each list entry will include the contact information of the friend/colleague such as telephone number, email address, instant messaging account ID or any other identification information that could be used to deliver a forwarded product/service offering. Each contact that is entered can be associated with a plurality of lists configured by the consumer subscriber, wherein each list includes individuals who are associated with one another (e.g., have a common interest relating to a product or service, etc.). The method then allows for the consumer who has received the offer to forward any product/service offering they receive to one or a plurality of pre-configured lists of friends/colleagues. The method also allows for friend/colleague receivers of forwarded messages (“secondary receivers”) to also forward the received product/service offers to their friends/colleagues (“tertiary receivers”). Secondary receivers who are also member will be able to forward the received product/service offerings using their own pre-configured lists. Secondary receivers who are not member subscribers will be able to forward the offerings by manually providing contact information such as email, instant messaging ID, telephone number or other unique contact identifiers. Secondary receivers who are not member subscribers will also be presented, on receipt of each forwarded product/service offering, with the opportunity to immediately subscribe to the gateway subscription service and configure their personal preferences for product/service offerings.

At least one embodiment described herein also comprises a method and/or system for automatically forwarding product/service offering to one or a plurality of pre-configured friend/colleague lists without manual intervention.

Various embodiments of the present inventions are set forth in the attached figures as provided herein. It should be understood, however, that the specification does not contain all the aspects and embodiments of the one or more present inventions, is not meant to be limiting or restrictive in any manner, and that the invention(s) as disclosed here is/are and will be understood by those of ordinary skill in the art to encompass obvious improvements and modifications thereto.

Additional advantages of the present invention will become readily apparent from the following discussion, particularly when taken together with the accompanying figures. These and other aspects of the present invention will become more fully apparent from the following descriptions, or may be learned by the practice of the invention set forth hereinafter.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1A is a pictorial representation of one embodiment of the gateway that is capable of delivering consumer-controlled, multimedia, marketing and advertising content over a communication network that provides for direct and targeted advertising of goods and services.

FIG. 1B is another pictorial representation of one embodiment of the ecosystem that is capable of delivering consumer-controlled, multimedia, marketing and advertising content over a communication network that provides for direct and targeted advertising of goods and services.

FIG. 2 is a block diagram of the gateway 200 that provides for consumer-controlled delivery of multimedia marketing and advertising, in accordance with one embodiment of the present invention.

FIG. 3 is a flow diagram illustrating a method for consumer-controlled marketing that is implemented within the gateway of FIG. 1A, in accordance with one embodiment of the present invention.

FIG. 4 is a data flow diagram 400 illustrating the implementation of the method of FIG. 3.

FIG. 5 is a flow diagram illustrating a method for creating an advertising campaign, in accordance with one embodiment of the present invention.

FIG. 6 is a flow diagram illustrating a method for launching an advertising campaign, in accordance with one embodiment of the present invention.

FIG. 7 is a flow diagram 700 illustrating a method for providing feedback in an advertising campaign that has been or is currently being implemented, in accordance with one embodiment of the present invention.

FIG. 8 is a flow diagram illustrating a method for generating, providing and using an audio coupon, in accordance with one embodiment of the present invention.

FIG. 9 is a flow diagram 900 illustrating a method for registration using a hyperlink, in accordance with one embodiment of the present invention.

FIG. 10 is a flow diagram 1000 illustrating a method for self registering on an interactive Internet website, in accordance with one embodiment of the present invention.

### DETAILED DESCRIPTION OF THE PREFERRED EMBODIMENTS

Reference will now be made in more detail to the preferred embodiments of the present invention, systems and methods for delivering consumer-controlled multimedia advertising, and more particularly to systems and methods for consumer-controlled specification, filtering and delivery of multimedia product/service offerings to “opted-in” consumers. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention.

In embodiments, systems and methods of delivering multimedia advertising can be used in conjunction with a wide range of broadcast media, including, but not limited to, radio, Internet, cable (and other Broadband Systems such as Digital Subscription Lines), mobile devices (such as mobile and smart phones), traditional telephone systems, and the like. While the present invention is described in context of several embodiments, such as the use of the invention in conjunction with mobile telephones, individuals skilled in the art will understand that the embodiments are not intended to limit the invention to these embodiments.

In particular, embodiments of the present invention are described in conjunction with a telephone-based user interface, such that business and consumer members may access the ecosystem preferences and features using the telephone based user interface. This could be rendered based on the use of “touch-tones” on the phone that are initiated by pressing dial pad buttons, and voice recognition techniques, or a combination thereof However, this implementation of an audio based gateway for managing and delivery of product/service offerings is intended to represent the management and delivery of product/service offerings of any suitable format, as will be further described below.

Accordingly, embodiments of the present invention facilitate more effective business-to-business and business-to-consumer marketing goals by optimally refining the content, quality, quantity and timing of product/service offer messages (a.k.a., “campaigns) so as to increase the relevance of marketing/advertising messages to a degree where a sufficient number of undecided, and currently non-consuming, receivers of the message are motivated by marketing message(s) to make a purchase of a product or service. Other embodiments of the present invention provide the above advantage and further provides for remedying the specific problems of “junk mail” and “spam”, as well as the entire class of problems that can be classified as being in the category of the “marketing/advertising problem”. One embodiment provides the above advantages, and further leverages the detailed personal preferences of each consumer to ensure that the messages the consumer receives from businesses are exclusively timely, relevant and appropriate to each consumer's personal tastes and preferences. Still other embodiments provide the above advantages, and further, offer an environment-friendly replacement to resource-intensive, wasteful and highly polluting marketing and advertising solutions currently in common use. Another embodiment provides the above advantages and delivers relevant, timely, and positively viewed marketing messages to targeted customers resulting in measurable, profitable increases in consumer buying activities. Still another embodiment provides the above advantages and further provides for consumer members and business subscribers to access and use the gateway using only a telephone user interface that uses touchtone and voice recognition as a mode of access and control.

As used herein, “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, C and/or C” means A alone, B alone, C alone, A and B together, A and C together, B and C together, or A, B, and C together.

### Notation and Nomenclature

Embodiments of the present invention can be implemented on a software program for processing data through a computer system. The computer system can be a personal computer, notebook computer, server computer, mainframe, networked computer (e.g., router), handheld computer, personal digital assistant, workstation, mobile telephone, smartphone, and/or the like. This program or its corresponding hardware implementation is operable for consumer-controlled delivery of multimedia advertising to include delivering and listening to audio, video, text content or desired combinations of these modes of content transmission and delivery. In one embodiment, the computer system includes a processor coupled to a bus and memory storage coupled to the bus. The memory storage can be volatile or non-volatile and can include removable storage media. The computer can also include a display, provision for data input and output, etc. The computer systems also comprise provisions for data input (e.g., touch screen, mouse, keyboard, eye tracking systems, voice recognition, pressure pads, and other human interface devices) and output.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “defining,” “determining,” “receiving,” “reducing,” “distributing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

At least one embodiment utilizes a recording of audio data or information. One skilled in the art will appreciate that the recording of data can be performed by both analog and digital methods into respective audio format. If a digital format is utilized, the audio recording can be made into uncompressed (such as .wav, .au, and .auff files) and compressed (such as .flac, .atrac, .tak, .aac, .mp3 and .wma) formats. Playback of such audio recording can occur directly on the listening device, by voicemail, as an attachment to electronic mail, downloadable file from an Internet webpage, and/or streaming audio media. Decoding of any digital information can be facilitated by an appropriate decoding software program respective to the manner of which the audio recording was delivered. One skilled in the art will appreciate that other forms of media such as text, video, or any other means of communicating marketing or advertising information, may be used in place of or as enhancement to a recorded audio data or information.

### Automated Multimedia Gateway for Consumer-Controlled Specification, Filtering and Delivery of Personalized Product/Service Offers

Embodiments of the present invention provide for consumer-controlled delivery of product/service offerings by repositioning the primary control of the generation of relevance in such messages, which in one implementation may be personalized. For instance, the primary control of marketing and advertising is taken out of the hands of businesses and put it completely into the hands of consumer subscribers. The invention implements an internet/web-hosted gateway where both consumers and businesses become subscribed members of a “buyer/seller” ecosystem. Once subscribed, consumers have direct and high fidelity control of all aspects of the marketing messages that are allowed to reach them from only those business members of the ecosystem to which they have indicated personal affinity. As a result, the acceptance to marketing messages that are delivered to consumers will be high and their response in terms of initiating a purchase will be much higher than the rates seen using traditional, legacy marketing methods.

Businesses members will have to change the way they approach marketing and advertising. Businesses members using an embodiment of the invention will no longer shoulder the heavy and unending burden of actively seeking out and qualifying customer leads though the use of aggressive and intrusive mass-marketing methods that target large, undifferentiated populations. Instead they have only to register their business into an embodiment of the invention, seed their business subscriber account with a population of their most loyal and active current customers, and then grow that loyal customer base over time using the tools provided in any embodiment of the invention. More particularly, embodiments of the invention will enable this as a successful approach by leveraging a specific and uniquely designed set of human, “social networking” dynamics to achieve extremely rapid growth in the size and activity of a membership-based ecosystem of consumers and businesses.

In embodiments of the present invention, the distribution of consumer-controlled marketing is achieved through connecting automatically from the gateway into the consumer's pre-existing social networks. A social network is a social structure that facilitates communication between a group of individuals or organizations that are related by one or more specific types of interdependency, such as: a special or common interest; shared values; visions, ideas, or perhaps ideals; financial exchange, friendship, kinship, dislike, conflict or trade. For instance, a social network may revolve around a consumer member, and includes business subscribers that the consumer member has selected from which marketing and advertising are received. These consumer social networks may include friends/colleagues of the consumer member who are also subscribers to the consumer-controlled gateway service and/or other friends/colleagues that are not already subscriber members.

In at least one embodiment, the systems described below are implemented as a part of a pre-existing social network. That is, a consumer member is able to integrate his or her existing social networks as a means for expanding the consumer-controlled gateway service. In this manner, social networks are able to monetize the targeting of advertising to the members of those social networks without allowing advertisers to merely drop or deliver advertising on user pages without user control or consent. As such, consumer members will still have final control over the delivery of product/service offer content. Other exemplary embodiments of the present invention will also provide for the distribution of consumer-controlled marketing outside of a pre-existing social network.

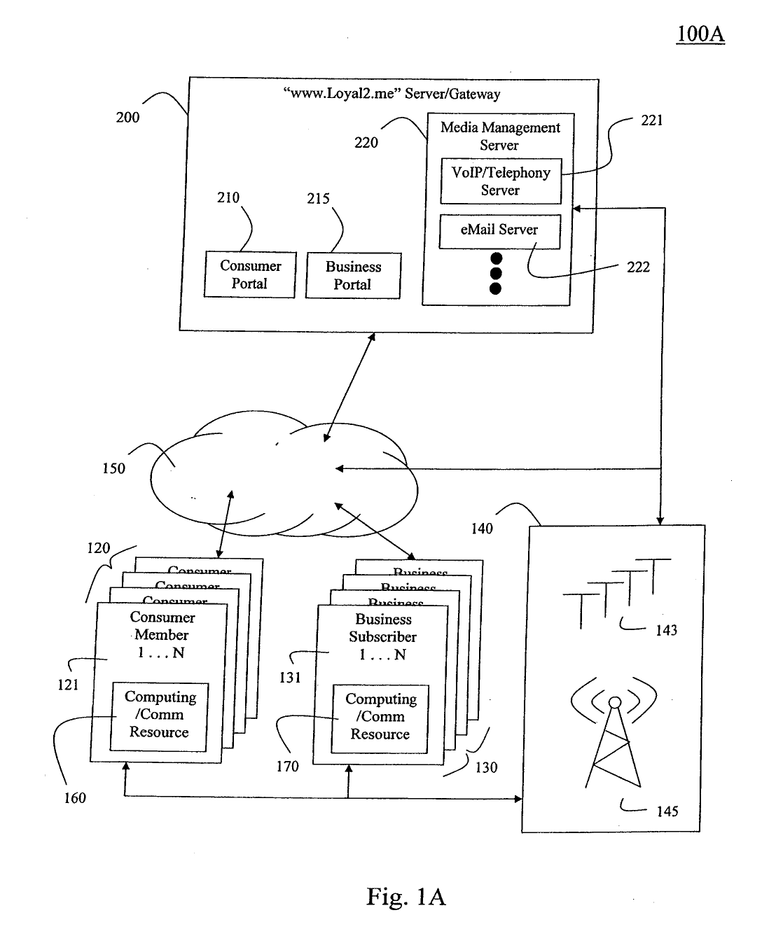

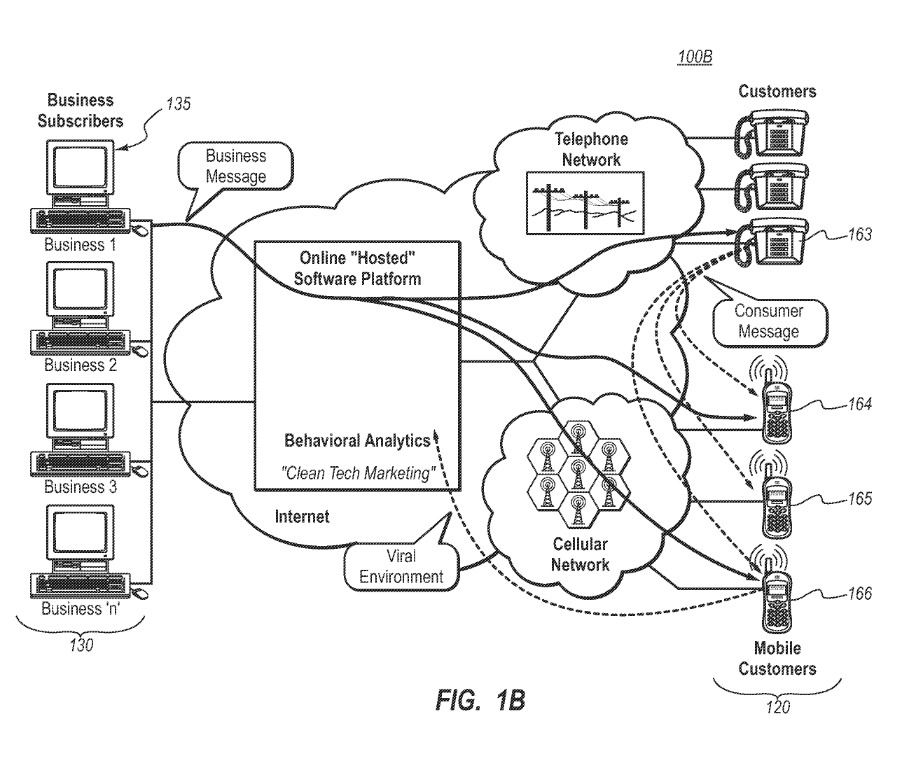

FIG. 1A is a pictorial representation of the ecosystem 100A that is capable of delivering consumer-controlled, multimedia, product/service offer content over a communication network that provides for direct and targeted advertising of goods and services, in accordance with one embodiment of the present invention. The ecosystem 100A generally describes a communication network suitable for distributing multi media advertising.

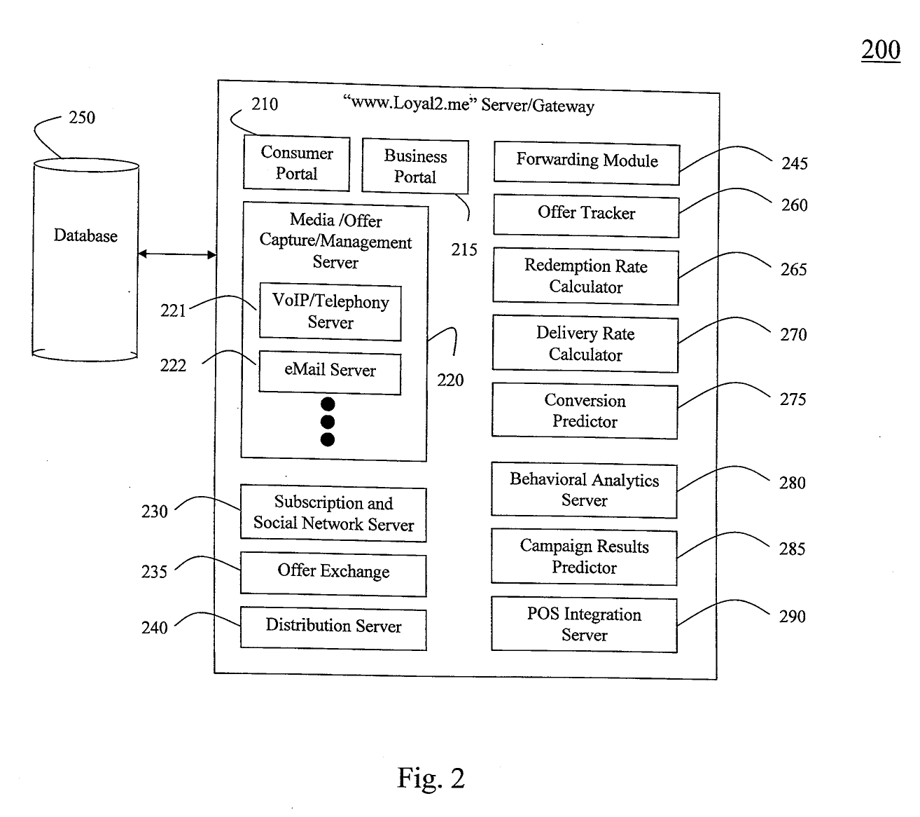

As shown, ecosystem 100A includes a plurality of consumer members 120, numbering from 1 to N, and a plurality of business subscribers 130, numbering from 1 to N. In addition, the ecosystem 100A includes a gateway 200 providing consumer-controlled delivery of multimedia advertising, which is more fully described in relation to FIG. 2. Gateway 200 also manages the one or more social networks that include the plurality of consumers 120 and plurality of business subscribes 130. In general, gateway 200 provides services to the plurality of consumer members 120 and plurality of business subscribers such that marketing and advertising originating from business subscribers is delivered in a fashion dictated by consumer members.

Each of the plurality of consumer members 120 is associated with one or more resources providing for computing and communication, and more specifically to interact with multimedia advertising (e.g., listen to, view, read, etc.). The resources provide, among other things, access and functionality to services, such as email, file transfer protocol (“FTP”), hypertext transfer protocol (“HTTP”) and access to the world wide web, or internet. For instance, a computing resource 160 allows a consumer member 121 to manage their subscription with the gateway (e.g., setting user preferences, etc.) through consumer portal 210, and to provide further communication with the gateway 200 via the media management server 220, such as when receiving multimedia marketing and advertising. More particularly, voice over internet protocol (VoIP) advertising messages are delivered via VoIP server 221 to a communication resource 160 associated with consumer 121. Media management server 220 is able to deliver messages using other formats, such as sending email advertising via email server 222 to communication resource 160 of consumer 121.

Additionally, each of the plurality of subscriber members 130 is associated with one or more resources providing for computing and communication. The resources provide, among other things, access and functionality to services, such as email, FTP, HTTP, and access to the world wide web through the internet. For instance, a subscriber member 131 may communicate with the gateway 200 via the business portal 215 using the resource 170 in order to manage their subscription. Also, business subscriber 131 may communicate with the media management server 221 to capture and/or create advertising used in marketing campaigns, or setting preferences in its corresponding business profile.

The plurality of consumer members 120 and the plurality of business subscribers 130 communicate with the gateway 200 through a communication network 150. Communication network 150, generally shown in FIG. 1A, is representative of any communication network enabling communication between devices in the ecosystem 100A, to include local area networks (“LAN”), wide area networks (“WAN”), the Internet, telephone networks, and other computer networks that distribute processing and/or share data among a plurality of nodes, “cloud” computing, or peer-to-peer networks capable of distributing information and needed services.

In one embodiment, ecosystem 100A includes a telephone network 140 that enables the distribution of data between the devices supporting ecosystem 100A. More specifically, telephone network 140 enables the distribution of marketing and advertising to the plurality of consumer members 120 from the gateway 200. In addition, telephone network 140 enables the plurality of consumer members 120 and the plurality of business subscribers 130 to communicate with gateway 200, as necessary, to manage their respective subscriptions.

As shown, telephone network 140 includes one or more public switched telephone networks (PSTN) 143, one or more wireless communication networks 145, and other types of networks suitable for providing communication. Telephone network 140 is able to operate independently of communication network 150, but also can be combined with communication network 150 to provide a full range of communication services to the plurality of consumer members 120, plurality of business subscribers 130, and gateway 200. In addition, gateway 200 includes appropriate network interface components for connecting to and interacting with public telephone (Voice TDM, VoIP, and short messaging service [SMS] interfaces) and public ‘internet data application’ networks. (Email, Instant Messaging, Web Services API's, etc).

FIG. 1B is an alternative embodiment of the ecosystem 100A, first presented in FIG. 1A. More specifically, ecosystem 100B is capable of delivering consumer-controlled, multimedia, marketing and advertising content over a communication network that provides for direct and targeted advertising of goods and services. As shown, ecosystem 100B illustrates the flow of multimedia marketing and advertising content from business subscribers to consumer members who are interested in receiving the content. For instance, multimedia advertising and marketing content is delivered from a business subscriber 135 to one or more consumer members 120. More specifically, the particular advertising and marketing content is delivered to a receiving device that corresponds to a consumer member, such as devices 163-166. The flow of multimedia marketing and advertising content to consumer members is further described below in relation to FIG. 2.

FIG. 2 is a block diagram of the gateway 200 that provides for consumer-controlled delivery of multimedia marketing and advertising, in accordance with one embodiment of the present invention. As previously described, gateway 200 is implementable within ecosystem 100A of FIG. 1A not only to provide for consumer-controlled advertising, but also to support the plurality of business subscribers that are targeting the consumers with multimedia marketing and advertising. The gateway 200 described herein may also comprise of a single server or multiple computers acting as individual servers interconnected with one another throughout a communication network.

As previously described, gateway 200 includes the consumer portal 210 through which the plurality of consumer members 120 can communicate with the gateway 200, and the business portal 215, through which the plurality of business subscribers 130 can communicate with the gateway 200. Communication with the gateway 200 by consumer members and business subscribers is provided for purposes of registration of new consumer members and business subscribers, management of preferences in consumer member and business subscriber profiles, capture and creation of multimedia marketing and advertising, and delivery of multimedia marketing and advertising, as well as other purposes. For instance, media management sever 220 provides for the capture and/or creation of multimedia marketing and advertising from the plurality of business subscribers 130. Media management server 220 delivers multimedia marketing or advertising content in various formats. As examples, the content may be in an audio, VoIP or email format, as supported by the corresponding servers shown. Other formats are contemplated, such as SMS text messaging, instant messaging, voice mail, video, etc. As such, media management server may be supported by one or more servers supporting the various formats, including an audio/voice management server providing audio marketing and advertising.

Gateway 200 includes a subscription server 230 that manages the subscriptions of both the plurality of consumers 120 and the plurality of business subscribers 130. In addition, subscription server 230 manages the social networks associated with the plurality of consumers 120 and the plurality of business subscribers 130. As such, consumer members and business subscribers are able to access the subscription server 230 to create accounts, enter personal and business information, and select other members and subscribers to be a part of a social network.

For instance, subscription server 230 supports the registration and management of consumer member profiles. In particular, a consumer member accesses and creates a consumer account, through a graphic user interface (e.g., internet browser) supported by the computing resource (e.g., personal computer), as managed by the subscription server 230. The consumer member submits detailed personal information including, but not limited to, age, gender, location, and other demographic information, and interests in a particular network of business service providers upon registering with the services provided by gateway 200. Subscription server 230 stores this information relating to the consumer member in a corresponding consumer profile in database 250. As such, the consumer portion of database 250 includes associated personal setting including user access information, demographic information, selections, personal preferences, personal media preferences, response data, and usage history, among others.

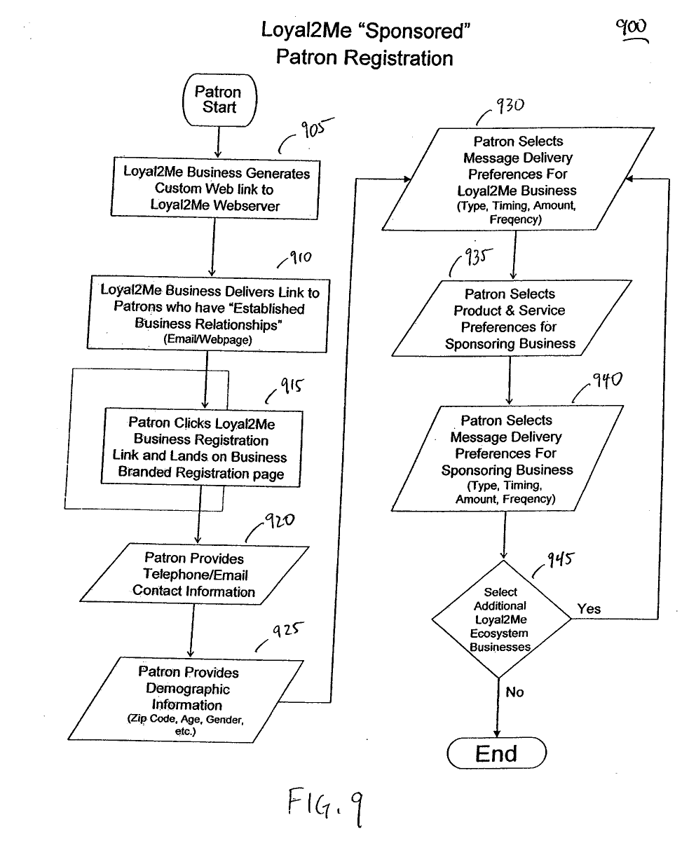

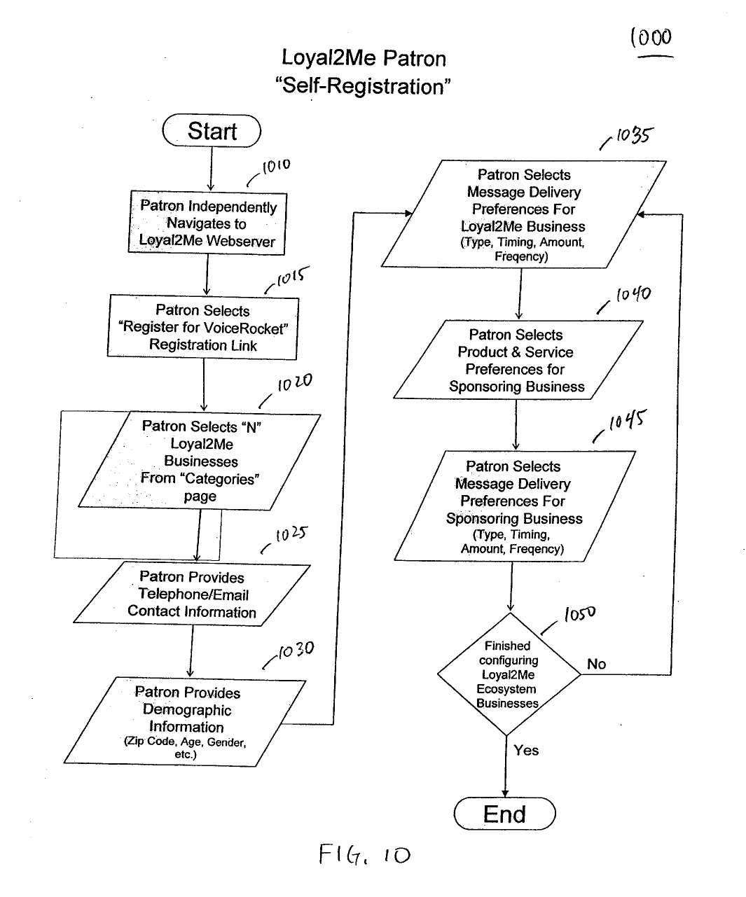

FIGS. 9 and 10 provide methods for registration with the gateway 200 implementing a system of consumer-controlled delivery of marketing and advertising content. In particular, FIG. 9 is a flow diagram 900 illustrating a method for registration using a hyperlink, in accordance with one embodiment of the present invention. The consumer registration process for this embodiment includes a customized web link that is generated by the subscriber server at 905. At 910, the web link is delivered by electronic mail or by direct hyperlink to a consumer that has an established relationship with a business. At 915, a consumer selects the hyperlink to the sent business registration link and is forwarded to a business-branded registration page (a web page that features advertising of the business subscriber). At 920, the consumer provides telephone and email contact information. At 925, the consumer may also provide demographic information. At 930, the consumer then selects the method of delivery and preferences associated with receiving information from the subscriber server. For example, the consumer is able to select the type of communication, the timing of communication and the amount and frequency of the communications provided by select businesses. At 935, the consumer selects product and or/services preferences for the present business. At 940, the consumer is queried to present delivery preferences, such as timing, frequency, and amount of delivery of marketing and advertising content. In addition, at 945 the consumer also then selects the product and/or services preferences for other potentially interesting businesses to the consumer. The subscriber server system can be divided into two units, one for businesses that the consumer has frequently used and, two, businesses that are similar to the consumer's marketing interests.

FIG. 10 is a flow diagram 1000 illustrating a method for self registering on an interactive internet website, in accordance with one embodiment of the present invention. For example, a consumer independently navigates to the web server at 1010, supporting the gateway 200 providing consumer-controlled delivery of product and service offers, and the consumer then selects the option of registering for a business account at 1015 to receive information from businesses that have established relationships with the consumer. The consumer is able to select businesses from category listings of businesses, at 1020. In a similar fashion to the registration process as described in FIG. 9 the consumer is welcomed on the subscriber server to a business-branded registration page wherein the consumer provides telephone and contact information and provides demographic information as well, at 1025 and 1030. The consumer selects message delivery preferences for businesses that have established relationships to provide the type, timing and amount of frequency of messages delivered by those pre-established business-relationship businesses, at 1030. At 1040, the consumer selects product and or/services preferences for the present business. At 1045, the consumer is queried to present delivery preferences for particular businesses, such as timing, frequency, and amount of delivery of marketing and advertising content. At 1050, other product and/or services preferences for other potentially interesting businesses to the consumer are selected to complete the configuration process.

Returning back to FIG. 2, subscription server 230 provides an interface through which the consumer member updates the associated consumer profile. For example, server 230 provides access via consumer portal 210 to consumer accounts so they can be managed. In one embodiment, the accounts are rendered in a web format appropriate either to a PC-based user interface or a small form-factor, handheld, wireless mobile device. (e.g. cell phone, personal digital assistant [PDA], tablet PC, laptop, etc.) so that consumer members are able to update their respective profiles.

In addition, the subscription server 230 enables the consumer to select and define preferences related to the goods and services that he or she would like to receive, as will be further described below. Also, the consumer member may predefine what types or categories of advertising he or she would like to receive. The consumer member may request advertising from certain service industries, only. Additionally, the consumer member defines what modes of communication are preferred when receiving delivery of multimedia marketing and advertising (e.g., audio, video, SMS/text messaging, etc.).

In other embodiments, the consumer member may also identify other current or potential consumer members having similar tastes and desires for similar goods and/or services. Additionally, the consumer member may also identify which goods and services that his or her friends are interested in receiving.

Also, subscription server 230 supports the registration and management of business subscriber profiles. For instance, the subscription server may receive demographic information from business subscribers, to include a brief description of its goods and/or services and the type of clientele it desires. As such, certain preferences may be defined by the business subscriber. This information, to include preferences, is accessible through a business subscriber profile stored in database 250 through which updates may be made to the profile. More particularly, the business subscriber portion of database 250 includes associated business settings, such as user access information, point of integration tools, subscription payment tools, business preferences, campaign media data, response data and analytical tools.

The offer exchange 235 then matches up preferences between the consumer and a business subscriber based upon the preferences selected and characteristics provided by both parties. Once a match has been determined, the offer exchange 235 communicates with the media management server 220 to deliver appropriate marketing and advertising content to the matched consumer member. The marketing and advertising content is created by a corresponding business subscriber, such that the media management server 220 captures and/or allows a business subscriber to create content and store it in database 250. For instance, the business subscriber can create, record, and modify audio advertising, video advertising, text messages with audio attachments, and/or other pre-stored multimedia messages. More generally, the media management server 220 allows business subscribes and consumer members to capture voice, text, and other media for appropriate delivery by the gateway 200 providing consumer-controlled delivery of marketing and advertising content to other consumer members and business subscribers.

Such marketing and advertising content is conveyed, distributed, and/or transmitted by a distribution server 240 through a variety of means, such as traditional telephone lines, mobile communications (e.g., cellular networks, GSM, CDMA, and the like), radio, broadband data lines, cable television, internet electronic subscription services (e.g., RSS), reading tablet subscriptions, podcasts, automatic postings to web logs (“blogs”) and/or direct communication systems such as instant messaging and other “Push-to-talk” solutions offered by communications service providers.

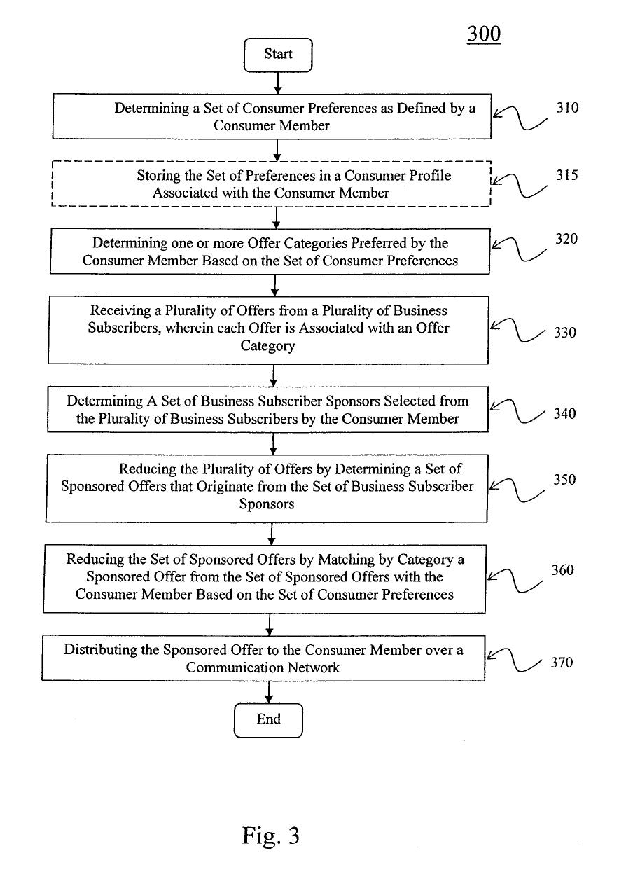

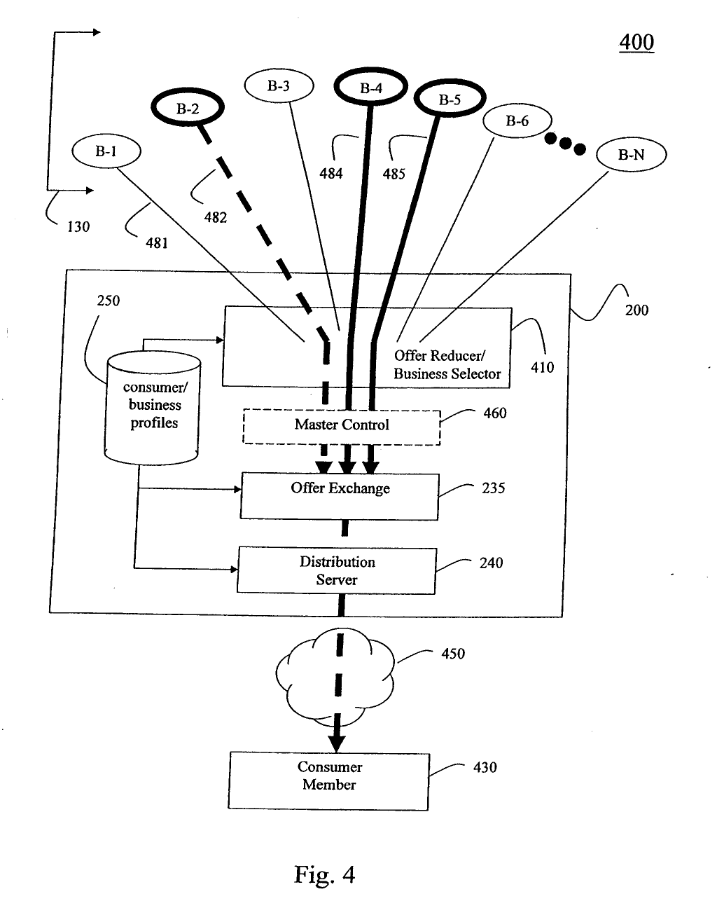

FIGS. 3 and 4 in combination illustrate an implementation of the consumer-controlled delivery of marketing and advertising. In particular, FIG. 3 is a flow diagram 300 illustrating a method for consumer-controlled marketing that is implemented within the ecosystem 100A of FIG. 1A, in accordance with one embodiment of the present invention. FIG. 4 is a data flow diagram 400 illustrating the implementation of the method of FIG. 3. That is, FIG. 4 illustrates how marketing and advertising content from business subscribers is delivered to an end consumer member as directed by the consumer member. As such, through the implementation of the method through the ecosystem 100A, a consumer member is able to receive marketing and advertising content that the member wants to receive, in a fashion desired by the member, and further at a time desired by the member.

Turning now to FIG. 3, the method for implementing consumer-controlled delivery of marketing and advertising begins at 310 by determining a set of consumer preferences as defined by the consumer member. This set of consumer preferences describes the consumer member as an individual. For instance, as previously described, the consumer preferences describe personal information of the consumer member to include, age, gender, location, contact information (e.g., telephone and email) and other demographic information. This information is optionally stored into a user profile of the consumer member, at 315. For instance, the user profiles are stored in database 250 of FIGS. 2 and 4.

In one embodiment, this preference information is provided by the consumer member upon registration with the system allowing the consumer to control the delivery of marketing and advertising. For instance, a consumer member may interface with gateway 200 by filling out a web-based form providing various information, to include: contact information (e.g., name, address, fixed and mobile telephone numbers, email address, instant messaging services/login names, etc.), and other demographic information (e.g., age, gender, income level, employer, job title, etc.).

As such, the consumer member begins to control the dissemination of personal information available to business subscribers participating in the system by selecting what personal information is stored into the corresponding consumer profile. In other embodiments, other personal information collected through the actions and activity of the consumer member may be included into the user profile of the consumer member in an effort to further define the interests and purchasing habits of the consumer.

In addition, the set of consumer preferences also define marketing and advertising of which the consumer member is interested. For instance, the preferences may define a particular network of business service providers that the consumer is interested. That is, the consumer member is interested in the products and services that that network of business subscribers provide. For instance, the consumer member is able to select products and/or services preferences for business subscribers of interest to a consumer. Still other consumer preferences may define business subscribers that the consumer member frequents and has an established relationship. As an example, the network of business subscribers may all be Mexican restaurants within a particular geographic area. As such, a consumer preference would define or help define those Mexican restaurants. As a result, marketing and advertising from those Mexican restaurants may be directed to the consumer member, as directed by the consumer member through his or her consumer preferences.

In one embodiment, consumer members may request (e.g., by telephone or web interface) to enroll a new interface, to enroll a new business member into the ecosystem 100A implementing consumer-controlled delivery of marketing and advertising content. These are businesses that they would like to select as a preferred business in their marketing message preferences.

For instance, a method for enrollment of new businesses that are not currently ecosystem members is initiated when a compelling number of existing consumer members of the ecosystem request the new business. The method involves the step of contacting each requested business and informing them that there are pre-qualified consumers members of an embodiment of the ecosystem invention who have registered specific interest in receiving marketing messages to be delivered to them from the non-member business being contacted. The non-member business will be informed that all messages to these consumers can be delivered via the embodiment of the ecosystem invention of which the consumers are members.

In another instance, the consumer preferences may define types or categories of goods and services, as well as types or categories of marketing and advertising directed to those goods and services. For instance, goods and services are grouped into various categories, wherein each group consists of one or more goods or services that have some association with each other. As an example, one category might be sports, such that goods and services related to sport activities are grouped together. The category may be further divided into various sub-categories, such as winter sports, summer sports, spectator sports, boating, etc. Other categories are contemplated, such as those relating to foods, restaurants, medical services, tax services, grocery stores, personal care services, automobile services, etc. As such, a consumer may provide preferences that indicate an interest in one or more categories. Similarly, a business subscriber may indicate that it is interested in sending advertising to those consumers who have preferences for certain categories, especially when that business subscriber is providing goods and services in those categories, as will be further described below.

For purposes of illustration, a particular category may relate to foods. A subcategory, or alternative category may relate to restaurants that provide foods. A consumer member may define one or more consumer preferences directed to the category of food, or to various related subcategories. For instance, the consumer member may define subcategories that define one or more of the following specials offered by restaurants in a particular area (e.g., zip code, metropolis, etc.). The consumer member may define a preference for Sunday specials, or midweek specials offering featured meals for particular times of the week at various restaurants. Still other preferences define particular types of restaurants by food offerings, or particular foods (e.g., hamburgers, etc.) Similarly, business subscribers may identify certain specials, discounts, or coupons on meals according to associated categories.

In embodiments of the present invention the term “offer” is intended to represent the various goods and services, as well as marketing and advertising directed to those goods and services available to a consumer member. For instance, an offer may consist of a meal special, a coupon redeemable for a discount on goods or services, a coupon redeemable for goods or services, a promotional price on goods or services, advertising directed to goods or services, marketing directed to goods or services, etc. In addition, the term “offer category” is intended to represent various categories for the above mentioned offers, to include goods and services, as well as marketing and advertising directed to those goods and services. For instance, an offer category may consist of offers related to foods, and more particularly, meals, discounts, coupons, promotional special related to Mexican restaurants in a particular location or region.

Still other preferences for the consumer member may define the method of delivery of advertising and marketing content, or offers, preferred by the consumer member, or more generally preferences in receiving information or data from the consumer gateway 200 implementing the system providing consumer-controlled delivery of marketing and advertising content. For instance, the preferences may define the type of communication, the timing of communication, and the amount and frequency of the communications provided by the business subscribers sending offers to the consumer member.

Turning back to FIG. 3, at 320, one or more offer categories are determined. These offer categories are preferred or desired by the consumer member, and are defined or based on the set of preferences associated with the consumer member. For instance, an offer category may define goods and services related to sports, or food, or restaurants, or certain types of restaurants (e.g., Mexican restaurants), etc.

Additionally, in one embodiment these categories are determined directly from the preferences, wherein one or more preferences distinctly define an offer category preferred by the consumers. In another embodiment, these categories are determined indirectly from the preferences. That is, one or more preferences infer that the consumer member would be interested in those categories. For instance, a category of Mexican restaurants may be inferred by the consumer member setting or being associated with a preference for burritos, or preferences for Latin food and eating out at restaurants.

At 330, a plurality of offers is received from a plurality of business subscribers. Each of the offers is associated with an offer category that further defines the offer (e.g., sports, foods, etc.). More particularly, offers from a plurality of business subscribers are submitted to the consumer gateway 200 implementing the system providing consumer-controlled delivery of marketing and advertising content. As previously described, the offers provide marketing and advertising content, to include offers to sell goods or services, and discounts or coupons for goods and services, to name a few.

Turning now to FIG. 4, a data flow diagram 400 is shown illustrating the implementation of consumer-controlled delivery of marketing and advertising content to the consumer member 430. For instance, a plurality of business subscribers 130, B-1 through B-N, is shown. One or more of the business subscribers provide one or more offers to the gateway 200 that facilitates consumer-controlled delivery of marketing and advertising content. An offer from a particular business is shown as a line emanating from that business and delivered to the gateway 200. For instance, an offer 481, as shown by a line, is submitted by business subscriber B-1 to gateway 200. Also, offer 482, as shown by the dotted and bolded line, is submitted by business subscriber B-2 to gateway 200, offer 484, shown by a bolded line, is submitted by business subscriber B-4, and offer 485, shown by a bolded line is submitted by business subscriber B-5. It is important to note that one or more offers may be delivered by a business subscriber to the gateway 200 for distribution to consumer members.

In one embodiment, the offer is part of or represents a marketing or advertising campaign. For purposes of illustration only, a marketing or advertising campaign is described as the creation and distribution of audio messages to consumer members. However, embodiments of the present invention are well suited to the creation and distribution of marketing and advertising content of varying formats, such as text messages, email, video, multimedia, or a combination thereof. For instance, a business subscriber is able to access, such as through a graphics interface, the media management server 220 of gateway 200 to create, edit and record an audio campaign, message, or coupon.

Turning back to FIG. 3, at 340, a set of business subscriber sponsors is determined. The business subscriber sponsor provides or sponsors advertising provided to the consumer member 430. More particularly, the set of business subscriber sponsors is selected from the plurality of business subscribers 130. The selection of business subscribers may be made directly by the consumer member 430 selecting each of the business subscribers in the set. For instance, the consumer member 430 may select, via web-based form or telephone user interface, a subset or set of business subscribers of the ecosystem from which they want to receive marketing and advertising content (e.g., offers). Also, business subscribers may be indirectly determined through behavior analysis of information related to the consumer member, or by classifying a type of business that the consumer member 430 is interested in, or by another selection method. For instance, the consumer member's preferences may indicate an interest in restaurants, and as such, newly opened restaurants may be automatically included in the set of business subscriber sponsors.

At 350, the plurality of offers is reduced by determining a set of sponsored offers that originate from the set of business subscriber sponsors. More particularly, the set of sponsored offers is provided by the set of business subscriber sponsors.

For instance, referring now to FIG. 4, the set of business subscriber sponsors 470 is shown to include business subscribers B-2, B-4, and B-5, and are further bolded in FIG. 4. As such, out of the plurality of business subscribers 130, the consumer member 430 is only interested in receiving marketing and advertising content from the business subscriber sponsors in the set 470. This is determined by the offer reducer/business selector 410 based on user preferences stored in a corresponding consumer profile in database 250. Correspondingly, offers associated with business subscribers in the set 470 are known, and can be filtered out from the plurality of offers provided by the plurality of business subscribers by the offer reducer/business selector 410. As such, offers represented by lines 482, 484, and 485 are filtered out.

Also shown in FIG. 4, is a master control 460 that provides summary control over information being delivered by the plurality of business subscribers 130, and more particularly by the set of business subscriber sponsors, in accordance with one embodiment of the present invention. In particular, the master control 460 acts as a switch that manages the flow of offers from each of the business subscriber sponsors in the set. In one embodiment, the consumer member 430 uses the master control 460 as an on/off switch, to either allow all of the offers from a particular business subscriber sponsor, or to prevent all of the offers from that sponsor. As an example for using the master control 460, the consumer member 430 may be going on vacation for a period of time, and does not want to receive any marketing or advertising content from one or more of the set of business subscriber sponsors. In fact, the consumer member 430 may shut off all or some of the marketing or advertising content received from the set of business subscriber sponsors, as well as from the plurality of business subscribers.

Turning back to FIG. 3, at 360 the set of sponsored offers is reduced. In particular, reduction is achieved by matching by category, one or more sponsored offers from the set of sponsored offers based to the consumer member based on the set of consumer preferences associated with the consumer member. That is, the consumer member may not be interested in all of the offers presented by the business subscriber sponsors. The consumer member's interest is defined by the set of consumer preferences, which directly or indirectly define categories of offers of interest to the consumer member.

For instance, turning now to FIG. 4, the set of sponsored offers is received by the offer exchange 235. Each of the sponsored offers is associated with a corresponding offer category. As described before, the offer category further describes the offer. As an example, a category could be sports, with subcategories of winter sports and skiing, summer sports and baseball, etc. Another example category could be food, with a subcategory of restaurants, in general within a geographic area. A particular subcategory could be Sunday specials offered by restaurants in that geographic area.

The offer exchange 235 also accesses the preferences of the consumer member 430 from a corresponding consumer profile stored in database 250. These preferences define offer categories having marketing and advertising content that the consumer member is interested in receiving.

As such, the offer exchange 235 is able to match the offer categories of interest to the consumer member 430 with those offers from the set of sponsored offers that are classified with the same offer categories. More particularly, if an offer category of interest to the consumer member 430 matches a sponsored offer that is classified with the same offer category, then there is a match. For instance, the consumer member 430 may have one or more preferences that indicate, either directly or indirectly, that he or she is interested in an offer category related to Sunday specials from restaurants. As a result, the offer exchange 235 is able to determine whether any sponsored offer is also classified as a Sunday special offer. If so, then there is a match.

As an illustration only, as shown in FIG. 4, the set of sponsored offers includes sponsored offer 482 submitted by business subscriber B-2, sponsored offer 484 submitted by business subscriber B-4, and sponsored offer 485 submitted by B-5. Sponsored offer 482 is associated with an offer category relating to Sunday specials from restaurants. Sponsored offer 482 is associated with an offer category relating to Sunday specials, and is indicated by the dotted line. Offer exchange matches sponsored offer 482 as being of interest to the consumer member 430, and passes it to the distribution server 240. Because the set of business subscriber sponsors is chosen by the consumer member 430, those restaurants in the set are probably in a given geographic area, such as a zip code where the consumer member 430 resides, frequents, or works. As a result, this makes the matched sponsored offer 482 more relevant to the consumer member.

Other examples of offer categories of interest to a consumer member are provided here to illustrate the matching of sponsored offers from business subscriber sponsors to offer categories of interest to a corresponding consumer member 430, as implemented by the consumer gateway 200 implementing the system providing consumer-controlled delivery of marketing and advertising content. For instance, a consumer member 430 may be interested in weekday lunch specials offered by restaurants that are business subscriber sponsors, a Friday meal special, coupons from newly opened restaurants in a given geographic area, coupons from newly opened Greek restaurants in a given geographic area, coupons from Mexican restaurants, coupons on sporting goods, offered discounts on tax services, specific goods or services, etc.

Turning back to FIG. 3, at 370 the sponsored offer found through matching is distributed to the consumer member over a communication network. For example, as shown in FIG. 4, the distribution server 240 receives sponsored offer 482 from the offer exchange 235. In one embodiment, the sponsored offer 482 is delivered to the consumer member 430 in a format preferred and indicated by the business subscriber sponsor or the gateway 200. In other embodiments, the distribution server 240 accesses the profile of the consumer member to determine the manner of delivery of the sponsored offer preferred by the consumer member 430, and the timing and frequency of the delivery of the sponsored offer.

For example, the consumer member 430 may indicate through preferences that marketing and advertising content be delivered only on a certain day of the week (e.g., Fridays before the weekend), delivered at a certain frequency (e.g., once every 4 days), delivered in a number not exceeding a cap over a period (e.g., 5 per day, 20 per week), or a combination thereof. The distribution server 240 is able to determine the timing and frequency of delivery from the preferences stored in the corresponding consumer profile in the database 250.

Additionally, the consumer member 430 may indicate through preferences the format of the marketing and advertising content (e.g., sponsored offer 482) delivered by the distribution server 240 to the consumer member 430. For instance, formats could include a voice recording over a fixed line or mobile phone; text-based format (e.g., SMS or email); multimedia based format (e.g., multimedia messaging service [MMS] or web browser).

### Advertising Campaign

The consumer gateway 200 implementing the ecosystem 100A providing consumer-controlled delivery of marketing and advertising content is capable of supporting a plurality of consumer members. As such, each consumer member is able to directly control corresponding delivery of marketing and advertising content. In this manner, an advertising campaign, as implemented and distributed through ecosystem 100A is targeted to consumer members that have requested, through preferences, marketing and advertising content associated with that advertising campaign, in accordance with one embodiment of the present invention.

More specifically, as shown in FIG. 1A, the ecosystem 100A includes a plurality of business subscribers 130 and a plurality of consumer members 120, both previously described. In addition, the plurality of consumer members is associated with a plurality of sets of consumer preferences. Each set of consumer preferences is defined by a corresponding consumer member and defines one or more offer categories preferred by the corresponding consumer member. In particular, the set of consumer preferences defines offer categories that are of interest to the consumer member. Additionally, the set of consumer preferences define other associative information, to include a set of business subscriber sponsors of interest to the consumer member, type of delivery of marketing and advertising content preferred by the consumer member, timing and frequency of delivery of those marketing and advertising content, etc.

In addition, the plurality of sets of consumer preferences is stored in a plurality of user profiles associated with the plurality of consumer members. More particularly, each of the plurality of sets of consumer preferences is associated with a corresponding consumer member, and is further stored in a corresponding user or consumer profile. These profiles are stored in database 250.

Additionally, the ecosystem 100A includes an advertising campaign of a business subscriber. The business subscriber is one of the plurality of business subscribers providing marketing and advertising content to the plurality of consumer members. That is, the ecosystem 100A is able to support the distribution and implementation of the advertising campaign, wherein the advertising campaign comprises a sponsored offer associated with a corresponding offer category.

Also, ecosystem 100A includes a gateway 200 that is capable of providing consumer-controlled delivery of marketing and advertising content. Specifically, gateway 200 includes an offer exchange 235 that is capable of matching by category a sponsored offer with a target set of consumer members based on a plurality of sets of preferences associated with the consumer members. More particularly, an offer category of a sponsored offer is matched to a consumer member, when preferences associated with that consumer member indicate his or her interest in the offer category. When the offer categories match, the offer exchange 235 is able to effect delivery of the sponsored offer to the consumer member, as previously described. This is accomplished for one or more consumer members who have expressed interest in an offer category of a sponsored offer. The target set of consumer members include the one or more consumer members.

An example is provided illustrating the implementation of an advertising campaign originating from a business subscriber, such that marketing and advertising from the campaign is targeted to consumer members requesting that content. In particular, the offer exchange 235 is able to match up the goods and services of the business subscriber to a subset or target set of the consumer members, registered for the services provided by gateway 200, who have expressed interest in those types of goods and/or services. Interest is expressed through one or more preferences actively submitted by the consumer members. In this implementation, the media management server 220 allows access to previously created or recorded multimedia content in the form of a message or offer, which contains marketing and advertising content, to include an audio coupon, special events, updates to the consumer's status and/or directions to the business.

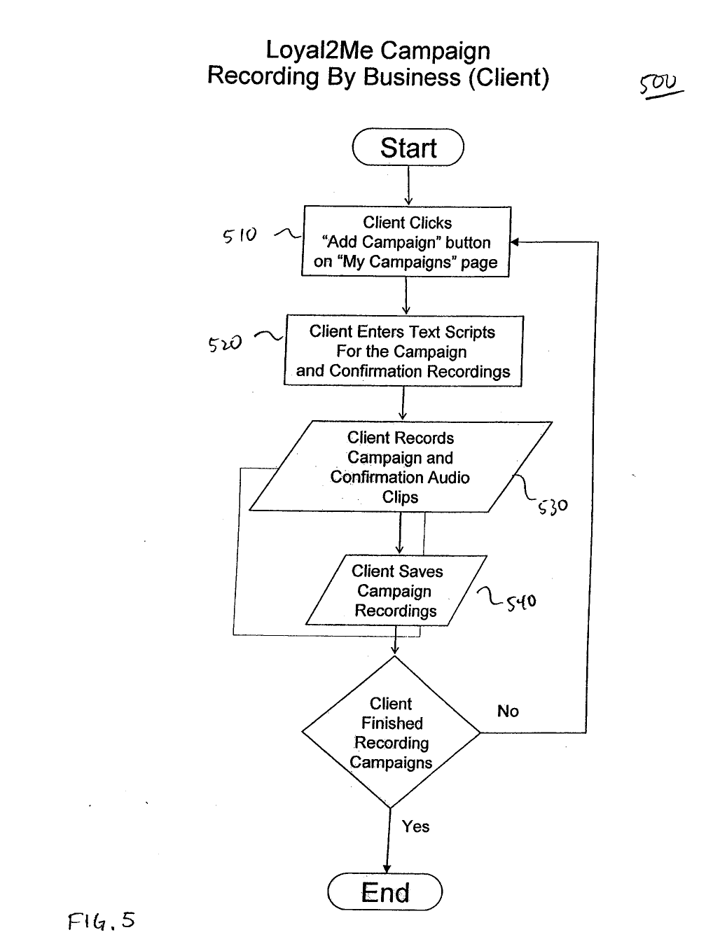

Using an example of an audio-based campaign for illustration purposes only, FIG. 5 is a flow diagram 500 illustrating the creation of an advertising campaign based in audio messages, in accordance with one embodiment of the present invention. Specifically, a business subscriber may create an advertising campaign by selecting text scripts for recording a campaign at 520. In addition, the business subscriber can prepare confirmation audio clips and determine how such business advertising information will be delivered to the consumer members. More particularly, at 530 through the graphic user interface (e.g., web browser) the business subscriber is able to access the subscription server 230 for facilitating the capture and creation of marketing and advertising content, and stores the content at 540. In one implementation, the business subscriber selects the option of creating an audio advertising campaign. The business subscriber is prompted by the subscription server 230 to enter in a text script for the advertising campaign and also record confirmation and audio information. The audio information and advertising campaign may also include an audio coupon that is recorded and saved for potential future delivery by the distribution server to appropriate consumers.

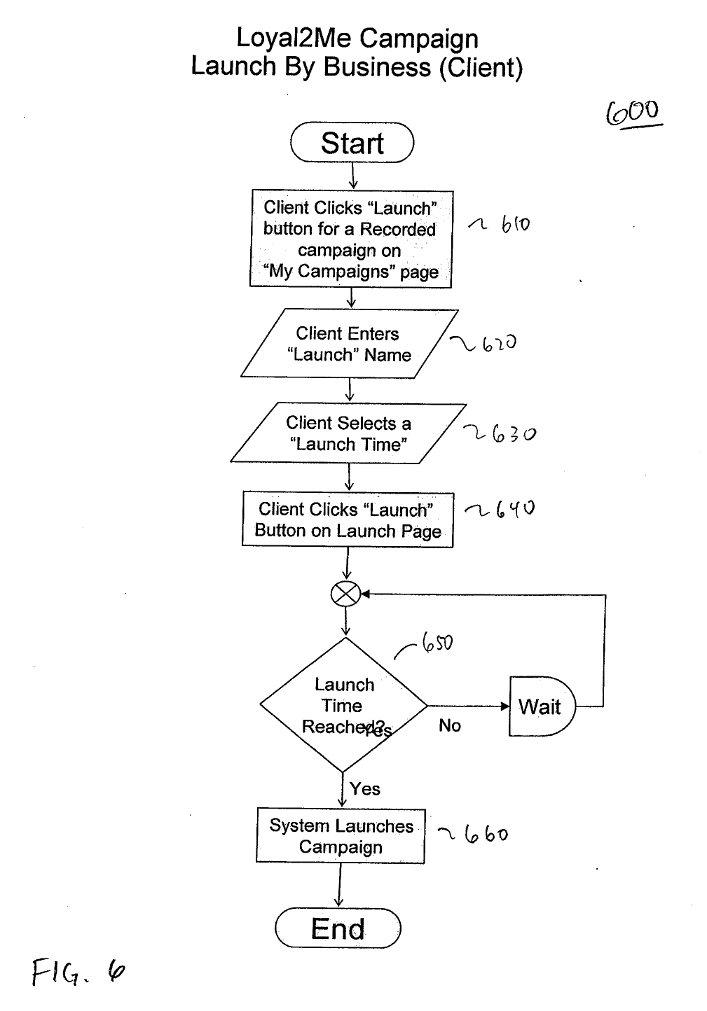

Further continuing the example illustrated in FIG. 5, FIG. 6 is a flow diagram 600 illustrating a method for launching a business campaign by a business subscriber, in accordance with one embodiment of the present invention. For instance, at 610, the business subscriber accesses the multimedia management server 220 at 610 to begin the launch process, on an existing advertising campaign. At 620, the associated files and information for the launch is accessed. For instance, through a graphical interface that is accessing the subscriber server, the business subscriber selects a prerecorded message, audio information, or audio coupon to be launched, i.e., sent to consumers that have the requisite characteristics and that have requested such type of advertising to be delivered. At 630, the business subscriber designates the launch time. For instance, the business subscriber is able to immediately initiate the launch of the advertising, or select a delayed or future launch time in which the subscriber server (in communication with other servers and services) will launch (i.e., send out audio messages, information or coupons) to a target set of consumer members, as previously described. At 650 and 660, when the time to launch is reached, the advertising campaign is launched.

For instance, upon launching the advertising campaign the media management server 220 in conjunction with distribution server 240 distributes the message or offer across either one or more of voice-over IP and telephony server 221 that connects to a public telephone network 143 and/or a cellular network and/or wireless data networks 145 (WiFi, WiMax, 4G, etc.) and/or the public internet and/or private, controlled data networks. Alternatively, the message can be encoded to various digital formats and sent to the consumer recipient as an attachment, visual voicemail or other multimedia attachment. Once the message is received, the consumer member can ‘listen to’, view, consume the message and then use the information to have directions to the business subscriber's location and/or provide for access to an audio coupon, or other multimedia content, that is triggered by the subscription server. As such, a business subscriber is able to utilize the subscription server 230 and distribution server 240 to deliver in bulk, at a pre-determined time and frequency, the pre-recorded audio, audio/video and/or subscription text messages to be delivered to the consumer member in the target set.

Further, the gateway 200 implementing a system for consumer-controlled delivery of marketing and advertising content is able to determine and calculate the number of messages sent out to interested consumer members, in accordance with one embodiment of the present invention. That is, instead of blindly distributing advertising to unsuspecting consumers, the gateway 200 implementing the system for consumer-controlled delivery of marketing and advertising content is able to predetermine how many consumer members is truly interested in receiving that content. For instance, the a delivery rate calculator 270 is capable of determining a total number of consumer members within the target set of consumer members who have expressed interest in receiving a particular offer relating to marketing and advertising content, and associated with an offer category. This number is known, since the gateway is able to determine which consumer members belong in the target set of consumer members to which the advertising campaign is directed.

In this manner, additional information may be provided to help the advertiser determine how and when to launch the campaign. For instance, an advertising campaign on a Wednesday may only garner twenty consumer members in the target set, whereas a launch of the advertising campaign on the following Friday may garner two-thousand consumer members in the target set.

In addition, the gateway 200 is able to determine a predicted rate of response provided by the advertising campaign. This information is then forwarded to the business subscriber as a predicted success rate of the advertising campaign provided by the system. The information may also be made available for display on the graphical user interface of the subscription server. For example, a conversion predictor 275 is able to determine a conversion rate of the advertising campaign (e.g., a proposed sponsored offer) within the discovered target set of consumer members. The conversion rate is determined based on historical data of the consumer members in the target set, as interpreted by the behavioral analysis server 280 that in part analyses information stored in corresponding consumer profiles. More specifically, the behavioral analysis server 280 employs advanced data-mining techniques to extract relevant trends in response and purchasing behaviors for businesses and for consumer users.

### Feedback in an Advertising Campaign

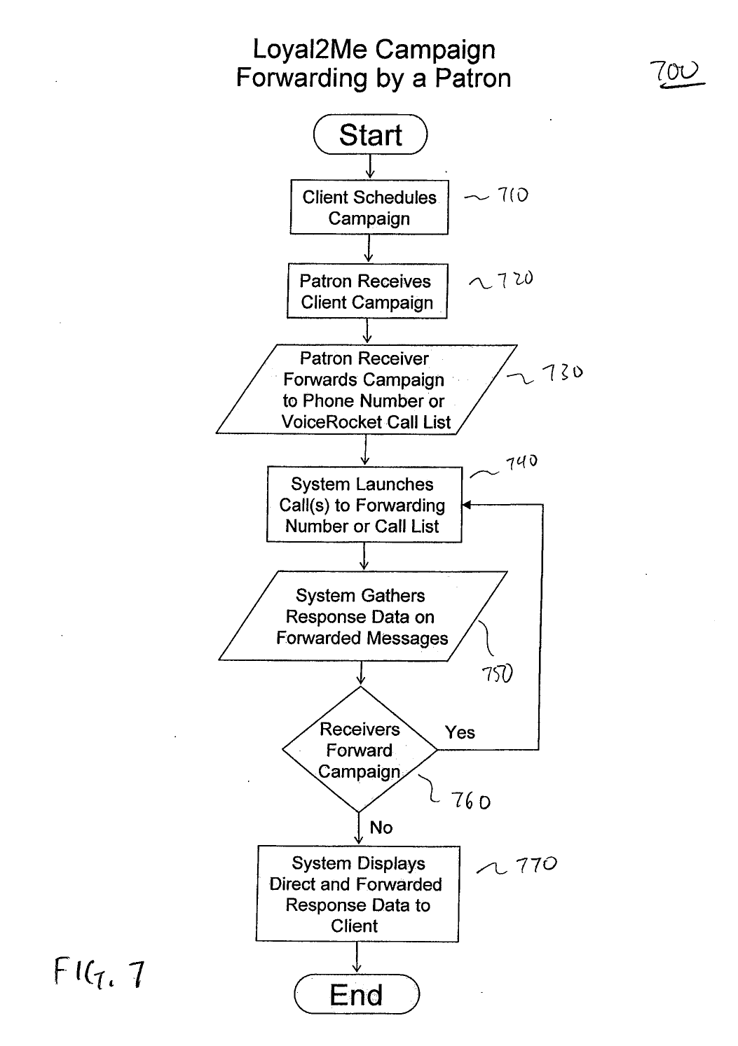

FIG. 7 is a flow diagram 700 illustrating a method for providing feedback in an advertising campaign that has been or is currently being implemented, in accordance with one embodiment of the present invention. Specifically, the gateway 200 implementing a system of consumer-controlled delivery of marketing and advertising content is also able to provide feedback information on the success of an advertising campaign.

For example, the gateway 200, through the offer tracker 260 and redemption rate calculator 265, is able to provide feedback on the success rate of a sponsored offer delivered to interested consumer members in a target set. The sponsored offer may comprise a coupon for a good or service, as an example. Further, the sponsored offer may include a unique identifier that uniquely identifies a coupon or sponsored offer to a corresponding consumer member in the target set.

A method is described for tracking the success of a marketing campaign launched via ecosystem 100A, in accordance with one embodiment of the present invention. For illustration, a campaign providing audio messages is described, but is representative of campaigns delivering marketing and advertising content of any format. For instance, at 710, the business subscriber schedules an advertising campaign.

At 720, a consumer member receives the advertising campaign. In particular, when a consumer receives a marketing message, or offer, and decides to respond affirmatively to the message the consumer makes some real-time indication of that intent by pressing a touchtone on the receiving telephone's dial-pad or otherwise “clicks” an affirmative response into a visually displayed user interface element. After successfully indicating an affirmative response, a completely unique “coupon code” is generated at the time of the consumer's affirmative indication of intent. This coupon code may be spoken out to the consumer member by a text to speech software feature and/or will be sent in text form via SMS text messaging or via email. This coupon code will be uniquely assigned only to the consumer member in question for the purpose only of being able to receive the specific product or service offer that was delivered to them, and to which they had just indicated positive interest. With this unique coupon code the consumer member will be able to go to the place of business of the establishment making the product or service offer and give the unique code to a representative at that business.

With that code the business representative is able to retrieve the details of the offer that was generated uniquely for the consumer by accessing the gateway 200. Upon entering the code, details of the offer is communicated, thereby enabling the business representative to perform this personalized coupon transaction. This entering of the coupon code at the point of sale event with the consumer also provides a precise connection or association of a campaign with a purchase event at the point of sale by a specific consumer member for purposes of conversion tracking. As such, offer tracker 260 is able to determine when a coupon code has been redeemed for a particular advertising campaign. Further, the redemption rate calculator 265 is capable of determining a redemption rate for the advertising campaign by considering the total number of coupons delivered to the target set of consumer members, and the number of coupons redeemed.

In addition, the consumer member may forward sponsored offer of an advertising campaign to other consumers. These forwarded offer is also tracked and included in the feedback mechanism provided in FIGS. 7 at 730, 740, 750, 760, and 770. In general, those operations define a method for consumer-controlled redistribution (“forwarding”) of product/service offers that have been received by a consumer is disclosed in another embodiment of the present invention. A consumer member is able to manually forward product/service offers they receive to friends/colleagues or other contacts in their social network, at 730. More particularly, forwarding module 245 forwards the sponsored offer to individuals or entities on a list of friends and/or colleagues at 740.

A consumer member may configure one or more lists on the gateway 200 that each include personal friends and/or colleagues. For instance, each list entry will include the contact information of the friend/colleague such as telephone number, email address, instant messaging account ID or any other identification information that could be used to deliver a forwarded product/service offering. Each contact that is entered can be associated with a plurality of lists configured by the consumer subscriber, wherein each list includes individuals who are associated with one another (e.g., have a common interest relating to a product or service, etc.). The method then allows for the consumer who has received the offer to forward any product/service offering they receive to one or a plurality of pre-configured lists of friends/colleagues.

In addition, receivers of forwarded messages (“secondary receivers”) are also able to forward the received product/service offers to their friends/colleagues (“tertiary receivers”) at 760. More specifically, secondary receivers who are also member will be able to forward the received product/service offerings using their own pre-configured lists. Secondary receivers who are not member subscribers will be able to forward the offerings by manually providing contact information such as email, instant messaging ID, telephone number or other unique contact identifiers. Secondary receivers who are not member subscribers will also be presented, on receipt of each forwarded product/service offering, with the opportunity to immediately subscribe to the gateway subscription service and configure their personal preferences for product/service offerings. The forwarded offer from consumer to consumer is capable of being tracked at 770.

### Audio Coupons

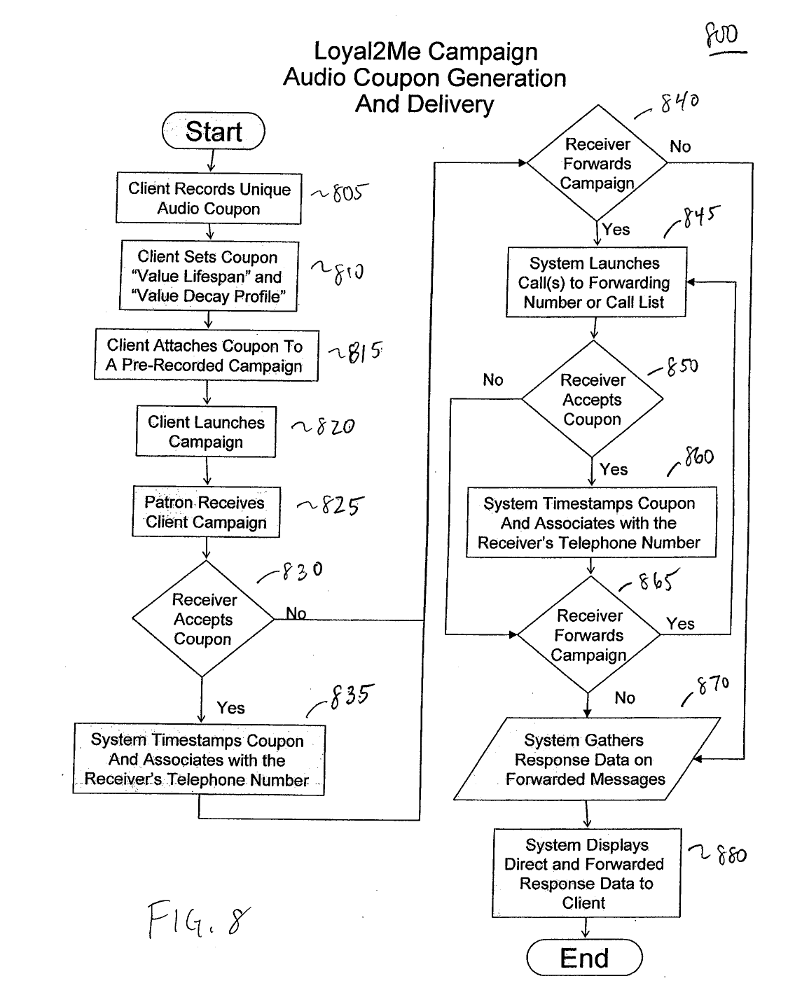

FIG. 8 is a flow diagram 800 illustrating a method for generating, providing and using an audio coupon, in accordance with one embodiment of the present invention. The use of an offer in the form of audio is intended to be representative of all offers of various formats that are implemented within a system capable of consumer-controlled delivery of marketing and advertising content.

As noted above, an audio coupon generation and delivery system is utilized within the gateway 200. An audio coupon is created and used by the following steps, which comprise: (1) recording an audio coupon at 805; (2) at 810, setting a value of the lifespan of the coupon and, if desired, the value of the half-life or decay profile of the coupon; (3) at 815, designating the audio coupon to be a part of the pre-recorded advertising campaign that is delivered by the business subscription server; and (4) at 820, initiating the campaign.

Additional steps may include: (5) at 825, the consumer member receiving the audio coupon or campaign information; (6) at 830, the consumer member accepting the coupon; and (7) at 835, time-stamping the coupon and associating the coupon with the receiver's telephone number. The consumer member, upon visiting the establishment of the business subscriber, is able to utilize the coupon based upon a confirmation code and the length of time between receiving the audio coupon and of visiting the business, as well as, any preset decay value of the coupon, described below.

In at least one embodiment, an audio coupon with decaying redemption value is used in the advertising campaign. Here, an audio message containing an audio coupon is recorded on the audio management server 220. The audio coupon may comprise a descriptive word or phrase that allows the consumers to use the coupon (i.e., redeem the coupon) when utilizing the services or purchasing the goods of a business subscriber. When the audio message containing the audio coupon is created by the business subscriber, a lifespan value may be set. This lifespan value determines the length of use of the audio coupon similar to an expiration date of a paper coupon. During the audio coupon creation process, the business subscriber may also set a decay value, if appropriate and desired. The decay value is the rate in which the discount for the business subscriber's goods or services decreases. For example, a business subscriber may set an initial discount value at 50% and a decay value of 10% per hour. Under this example, if a consumer were to redeem the audio coupon with the business subscriber within the first hour, the consumer would receive the full benefit of the 50% discount. However, should the consumer redeem the audio coupon two hours after receipt, the value of the discount may have “decayed” to 40% and so on. Similar to other embodiments described herein, a consumer that does not wish to redeem an audio coupon may manually forward or utilize the subscriber server to automatically forward the audio coupon to other acquaintances or other members of his or her social network located on the subscriber server. An alternative embodiment of this decaying audio coupon allows for the consumer to temporarily halt or pause the decay value of the audio coupon by submitting a request though his or her listening device, such as pressing a touch tone during the play of the audio coupon.

In at least one embodiment, messages or offers associated with the advertising campaign can be delivered by telephone to a voice messaging system, over a cellular network to a mobile handset and voice messaging system, and/or as an electronic audio file to be delivered as an SMS text message and/or an electronic mail message to designated recipients.

In at least one embodiment, the system may be utilized to promote personal events such as a party by allowing the subscriber to pre-record messages and/or provide additional text information for the personal event.

Additionally, the forwarding module 245 provides for forwarding of the coupon to other members in a social network of consumer members. That is, a consumer member who receives the coupon may forward the coupon to other members of the social network. For instance, if the consumer member does not accept the coupon, then he or she has the opportunity to forward the audio coupon to an individual or a pre-determined list of individuals to receive coupons (i.e., a list of friends who would be interested in similar goods and/or services in a social network). The present invention gathers response data on forwarded messages in the implementation of a reward system, described below.

For example, at 840 the consumer member may manually forward product/service offers they receive to friends/colleagues or other contacts in their social network. As such, at 840, a sponsored offer is forwarded to a receiver. More particularly, the consumer member may forward the sponsored offer to one or more consumers on a list, at 845. For instance, those on the list may have designated the consumer member to be a proxy, such that advertising in a particular category delivered to the proxy is also delivered to those on the list. In one case, those on the list may not even be known to the proxy consumer, however, the proxy consumer has earned a reputation of expertise in an area (e.g., food critic for Mexican restaurants) that other consumers would like to take advantage of offers delivered to that proxy consumer.

At 850, the secondary receiver is able to accept the sponsored offer (e.g., coupon). That is, the secondary receiver receives the audio coupon or campaign information, and accepts the coupon. In addition, at 860, coupon is time-stamped, and the coupon is associated with the secondary receiver's telephone number, in part for tracking purposes. At 870, the secondary receiver is able to forward the sponsored offer to other consumer, as tertiary receivers, and so on.

### Audio Reservation and Auction System

In a separate embodiment that uses a real-time consumer-controlled marketing system, a voice option may be selected to simultaneously inform a group of consumers of a deep discount on a limited inventory item. By way of example and not limitation, an audio system message states how many items are available at the discounted rate. The system provides for consumers to press a touchtone button on their phones to immediately reserve one of the items. As an option, the cost of the discounted item may be tied to established credit (or bank account information) of the registered user. The system is able to determine and time-stamp the order of the sequence of reservations by multiple individuals (i.e., the system would be able to rank by first in time requesters of a particular item). In addition, the telephone messaging system allows the consumer to forward his or her reserved item, along with a pre-recorded message, to a list of pre-screened recipients who may be interested in the similar item.

### Virtual Location Based Services (VLBS)/Self-Reported Location Based Services (SRLBS)

In at least one embodiment, the business subscriber pre-configures personalized discounts that are delivered by telephone call to specific consumers based on the location of the consumers relative to the location of the business subscriber. By way of example, the subscription server 230 requests a consumer member to provide personal location information. The subscription server 230 returns information by way of text message, audio information or audio advertising of nearby business subscribers providing discounts.

For example a consumer member might arrive at a shopping mall and decide to communicate with the subscription server 230 his or her location by text message, mobile web browser, or mobile software application. The subscription server 230, via the distribution server 240, distributes audio messages of business subscribers in proximity to the consumer member, such as those located in the mall.

The consumer can self-report his or her location whether or not he is actually physically in that location, in one embodiment. Alternatively, a GPS-based location system or triangulation-by-cell-tower-based system may be used to track the consumers' precise location. As a modification to the system, the consumer could falsely indicate that he or she is in the mall. The gateway 200 still responds to the consumer and delivers any subsequent calls with offer or discount information. This approach allows for the business and consumer benefits and convenience of “location-based services” without a continuous compromising of the consumer's location privacy.

In another embodiment, the consumer member's preferences are examined to determine a list of business subscribers, the set of business subscriber sponsors, that are allowed to send messages, as previously described. This embodiment would then automatically launch a call to the consumer's mobile device delivering one or more discount offers via audio or text coupon from those business subscriber sponsors making offers. For example: a consumer may use a mobile telephone software application to select “Flatirons Mall” as the general location for which he or she is interested in receiving discount offers. The consumer member may further define the set of business subscriber sponsors to “Stores 1 and 2” located in Flatirons Mall, as being the only businesses that he or she is interested in hearing offers from. Should Store 1 or Store 2 have pre-configured offers ready, those offers are delivered in audio format, such that the consumer's phone rings, and the consumer member can hear one or more recordings of the offers available for the day.

At least one embodiment may provide for telephone call connection directly to the business subscriber store of interest. This would provide for the consumer to ask questions about the store or offers while walking toward the store. Alternatively, a consumer may desire to hear more audio information content than what is provided for as part of his or her subscription profile or preferences. At least one embodiment would allow a consumer to hear all audio recordings/coupons and/or information for a given location and participating business subscribers.

In still another embodiment, the set of business subscriber sponsors is translated to another geographic area. That is, the set of business subscriber sponsors is typically associated with a geographic area of interest to the consumer member. The geographic area may relate to a business park, a mall, or a zip code including the consumer member's residence or work, or any other area that the consumer frequents. As an example, a list of business subscriber sponsors may include a grocery store, a gym, a movie theater, a gas station, and any other business establishment that the consumer member may frequent.

This list of business subscriber sponsors may be translated to create a second list of business subscriber sponsors applicable to a second geographic area. As an example, the consumer member may be moving from one geographic region (e.g., Denver) to another geographic region (e.g., Los Angeles). As such, the original list of business subscriber sponsors may be translated to include pertinent business subscribers that are located in the second geographic region. In that manner, the consumer member could access the translated list to find corresponding business establishments that may be of interest to the consumer member.

### Market Exchange

In an embodiment of the present invention, a market exchange is capable of matching bids and/or offers for goods and services between consumer members and business subscribers. An example of matching bids and offers provided in audio format is used for illustration purposes only, and is representative of bids and offers provided in any communication format, such as text instead of voice as an information delivery format.

The market exchange is implementable when a critical mass of population of business and consumer subscribers a new model of business/consumer interaction will emerge in a second stage of the evolution of any embodiment of this ecosystem invention. In this second stage, consumers will be able to make real-time, verbal requests for products and services by making a phone call, or in any other manner recording and forwarding a verbal request, that is subsequently delivered into the ecosystem of business members. The request is in the form of a bid for a product or service. In one embodiment, the bid is associated with an offer category. In another embodiment, the offer category is one preferred by the consumer member submitting the bid.

As an example, the market exchange is capable of implementing a method for a consumer member to use a telephone to request a specific product or service, as a bid, in real-time and have business subscribers compete for the fulfillment of the business request. Upon implementation of the method, a special communication mechanism is enabled by which a consumer member of the ecosystem 100A can indicate, that they want to record a detailed voice-based request for a product or service. Upon receiving the request, the ecosystem 100A uses voice recognition technology, or live call center agents trained in this skillset, to classify or categorize the request.

Embodiments of the invention will submit a bid by first automatically classifying and delivering those requests to appropriate businesses in the ecosystem. Those businesses that are selected to see the request will then be able to respond in real-time with verbal offers intended to fulfill the consumer request.

Once the request is classified by type of product or service the ecosystem will select a list of no more than seven businesses, for example, that provide the desired service or product and forward the full recording of the consumer request to those businesses for processing and consideration. That is, a presenter will select the recipient business subscribers, and present the bid to them. The choice of businesses is made using intelligent selection algorithms designed to increase the likelihood that the selected businesses can provide an attractive and relevant product or service offer to the consumer. For instance, the set of business subscribers may have preferences indicating an offer category matching that of the bid.

Upon receiving the consumer message, interested business subscribers may choose to respond immediately with an offer, recorded in voice format, outlining their offer for the requested product or service. Business subscribers may also decline to make an offer, and if that happens the next business subscriber in the queue created by the intelligent selection algorithm is notified.

All the responding business subscriber offers are batched together into a single voice recording or using any other communication mechanism, that is then delivered back to the requesting consumer either in an email attachment, multimedia phone message (MMS) and/or preferably via a live voice call. The returned audio recording will be a sequential capture of all the responses from the business subscribers that have chosen to make fulfillment offers. Upon receipt of the batch response message the consumer member chooses which of the fulfillment offers they want to accept using dual tone multi-frequency (DTMF) touch tones initiated using their telephone dial pad, or any other response feature (e.g., touchtone, verbal recording, text message, multimedia message). Also, the consumer member can choose to decline all offers or indicate which of the offers is being accepted.

Once the consumer chooses one of the offers the ecosystem notifies the chosen business subscriber and initiates a live call out to both the business and the consumer and connects them onto a call to complete the planning for the transaction. For instance, the POS integration server 290 establishes communication between the consumer member and the business subscriber in order to facilitate the details of completing a transaction of the sale of the good or service, to include connecting buyer and seller on a live voice communication session, and optionally playing the role as point of sale agent for completing the financial portion of the agreed to transaction.

### Viral Expansion Loops and Reward System

Embodiments of the invention will leverage a novel system of “viral expansion loops.” A “viral expansion loop” is defined as a member enrollment feedback mechanism implemented so as to generate recursively reinforced growth in the number of subscribers to, and active users of, a consumer/business ecosystem. For instance, a viral expansion loop may be described as a social network of consumer members and business subscribers all being associated with a particular consumer member or business subscriber. A universe of viral loops is created from the social networks involving consumer members and the business subscribers. As a result, the viral loops are interconnected in a cross-coupled manner, and reinforce one or more other loops in a recursive and positively-reinforcing manner.

A community of people in the social network of the legally qualified or licensed operators of an embodiment of the ecosystem invention are chosen as the initial consumer “founder” members of the ecosystem. This founder community will be comprised of those individuals who have expressed very strong interest in being active advocates of the community. An initial rapid expansion will happen by allowing these handpicked “community founders” to expand membership using an “unlimited invitation plus rewards” feature of an embodiment of the invention. Each instance of a successful recruitment of a new consumer subscriber or business subscriber by a founder will result in a reward being earned by the recruiting founder. This approach builds the population of any embodiment of the ecosystem invention so as to produce a highly socially, interconnected population from the very first day of the existence of the ecosystem. This approach is critical to sustaining the member retention, (a.k.a. “stickiness of the solution”)

Expansion of the loyalty or rewards program is accomplished in the following manner, in accordance with one embodiment of the present invention. A business subscriber adds contact information and demographic data of their current, “opted in” loyalty program consumers to the gateway system implementing consumer-controlled delivery of marketing and advertising content. As new consumers enroll in a member business's loyalty/rewards program, the new consumer's demographic information would be added to the database of the gateway of the ecosystem 100A. The business subscriber sends an initial notification message to these consumer members using the tools provided by an embodiment of the ecosystem invention. Upon receiving a message from this business subscriber, the loyal customer is prompted to enroll as a member of the same embodiment of the ecosystem invention. Receivers of the initial invitation message hear a message such as. “Press # to get an email invitation to control all advertising and marketing messages from your favorite businesses.” If the loyal customer indicates a positive response to the invitation, the receive an email, to which they can click a web link to register on the web with an embodiment of the ecosystem. Business subscribers are rewarded with “Ecosystem Points” for every new ‘loyal customer contact’ that converts to be a new consumer member of the embodiment of the ecosystem 100A. “Ecosystem Points” can be redeemed by businesses for premium data-mining services, other premium features/services or additional messaging usage minutes.

As a further model for expansion, after signing up for personal control of their marketing stream from an initial preferred business, consumers members are queried to list all of their favorite businesses that are not currently in our ecosystem, in accordance with one embodiment of the present invention. The gateway 200 of ecosystem 100A then allows consumer members to send personal, ecosystem enrollment messages directly to a known business owner. (e.g., “Hi this is Joe, one of your loyal customers. I use the “Consumer-controlled Marketing Ecosystem” to subscribe to personalized marketing from my favorite businesses. I would like you to join the ecosystem and send me messages about your products and services.”). Alternatively, they can just record the above message and the operators of an embodiment of the ecosystem will make sure the message is directed to a marketing decision maker at that business. Consumer members are rewarded with “Reward Points” for every new “referred business” contact they enroll in the ecosystem database. Consumer members can redeem these “Reward Points” for premium personal messaging features or other special rewards. (Free merchandise, services, etc.).

As a further model for expansion, after signing up for personal control of their marketing messages from an initial preferred business, consumer members are asked if they themselves are a business owner or a marketing-tools decision-maker at a business. If the consumer member indicates in the affirmative they are prompted to enroll their own business into the ecosystem. Consumer members that proceed to enroll as business users are rewarded with bonus “Reward Points” for their initial business enrollment that can be redeemed for free premium services. For every new consumer contact they have in their business, which they enroll into and contact through the ecosystem, they receive “Reward points”. “Reward Points” can be redeemed by these businesses for value added, data-mining services, premium features or additional usage minutes.

A further model for expansion includes a “share the deal with friends” loop. The method for expansion includes encouraging enrolled consumer members of the ecosystem, who receive marketing messages, to forward business offers/coupons/promotions to friends in their personal network for reuse of the offer, coupon, and promotion. People receiving these forwarded messages are prompted with a pre-pended “audio splash” message inviting them to enroll in an embodiment of the ecosystem invention and participate as consumer members. (e.g., “Press # to enroll in the Consumer-Controlled Marketing Ecosystem”). After indicating a positive response, indicating intent to enroll, the message receiver is prompted to provide email contact and other information by recording a voice message directed at the operators of the embodiment of the ecosystem invention. Using that information the ecosystem provides the new subscriber with an email based invitation containing all the information necessary to fully enroll as a consumer member of the ecosystem. A consumer user that forwards offers from preferred businesses to non-enrolled friends is rewarded with “Reward Points” both for initially forwarding a marketing message; and again for each of the people they forward to that subsequently enroll as full ecosystem members.

A further model for expansion includes a “social organization loop”. The method for expansion includes giving to enrolled consumer members of the ecosystem who receive marketing messages free access to a set of person-to-person multimedia messaging tools that are used to send personal messages to friends and or groups of friends. Each time an enrolled member user enters a friend or colleague's contact information the user is prompted to send an invite email or voice message asking the friend to become an ecosystem member. Also every personal message sent to non-subscribers is pre-pended with a 3 second audio, video or text splash message, asking them to join an embodiment of the ecosystem invention. Consumer members that send person-to-person messages are rewarded with bonus “Reward Points” the first time they send messages to friends who are not members of the ecosystem. Consumer members are rewarded again with “Reward Points” for each of those people they send messages to that subsequently enroll in the ecosystem.

A further model for expansion includes an “employee organization” loop. The method for expansion includes leveraging the person-to-person messaging features of an embodiment of the ecosystem invention in a business context for communicating with and organizing employees regarding work related topics. Businesses therefore require all employees to become subscribed users by opting-in their cell phone and or home number for person-to-person messaging use. Ecosystem businesses that use this feature of an embodiment of the ecosystem are rewarded with “Reward Points” for each new employee contact they enter into the ecosystem database. Businesses are rewarded again with “Reward Points” for each employee that subsequently upgrades their ecosystem subscription to also be a consumer user of the embodiment of the ecosystem invention.

A further model for expansion includes an “employee as a consumer” loop. The method for expansion includes sending an invitation to those employees whose cell numbers are added to the database of the gateway 200 in the context of a work communication tool. The employee is invited to set up a consumer member subscription. The subscription includes features allowing the member to send person-to-person messages and/or for access to the capacity to design and control their own personalized preferences for receiving marketing from preferred businesses. Employees that enroll for personal use, after having been added as part of where they work, are rewarded with a “Reward Points”.

A further model for expansion includes a “partner vendor organization” loop. The method for expansion allows business subscribers enrolled in the ecosystem to enter into the ecosystem database a list of business partner entries containing contact information (e.g., suppliers, partners, vendors, business customers etc.). Enrolled business subscribers then use the message capture and delivery tools of an embodiment of the ecosystem invention to communicate and coordinate business interactions with these professional business contacts. Business subscribers are encouraged to personally invite business contacts to subscribe to the embodiment of the ecosystem invention by offering “Reward Points” for adding business contact information to the ecosystem and for every business partner that subsequently enrolls in the ecosystem. Each message sent to a non-enrolled business contact is appended with an audio splash message, inviting them to enroll in the embodiment of the ecosystem invention.

In one embodiment, a “double-ended reward multiplier system,” wherein when the ecosystem 100A is used to send or receive messages, all parties are rewarded for; initially enrolling in response to an invite; and for inviting the next set of new users.

In one embodiment, the interconnected loops of the ecosystem 100A is modeled mathematically using ‘state space’, linear system mathematics/modeling, in order to proactively drive more effectiveness into the marketing campaigns executed by business members of an embodiment of the ecosystem invention. The method for expansion includes modeling the viral expansion loops using ‘state space’, linear system mathematics, and measuring the outputs of each of the viral expansion loops and using those outputs to mathematically estimate and predict the most likely behaviors of consumer and business users of an embodiment of the ecosystem invention. Over time as these mathematical models become increasingly accurate in predicting behaviors, the system will be accurate in predicting the response rates of any given campaign before it is launched, as previously described.

To maximize the fidelity and accuracy of the models and the ability to drive specific behaviors in response to campaigns, any embodiment of the ecosystem invention will make automatic real-time adjustments in amount and nature of the “Reward Points” reward multipliers in order to proactively drive any embodiment of the ecosystem invention to desired, stable states in an observable and controllable fashion.

A next step will be the implementation of a real-time, data-mining (measurements) engine that would in “real-time” do LQE estimation (Kalman Filtering , etc.) to reveal system states of interest with the goal of achieving observability and controllability of ecosystem states and state transitions in all of the viral expansion loops. The final step will be to look closely at, and predict precisely, the time-varying, non-linear properties of the system states represented in the transfer function matrix of any embodiment of the ecosystem invention model. (e.g. How does campaign effectiveness vary by time of day, week, month, season relative to identifiable demographic groups, etc?).

The business member outcome of this will be a “real-time recommendations” feature set for business owners/managers that proactively notifies them when conditions are ideal to launch specific types of marketing campaigns that are highly timely and relevant to the consumers that are targeted to receive the messages. The recommendations would include information about when to launch a message, what subsets of the population to which the message should be targeted and also the type of offer/message to which each population is most immediately receptive. In every case all messages are always filtered against each consumer user's personal settings.

Accordingly, embodiments of the present invention describe methods and systems for implementing a highly effective, efficient and environment-friendly marketing and advertising ecosystem comprised of consumers and businesses. More particularly, the consumer members of the ecosystem are given complete and detailed control of all marketing impressions received from business members of the ecosystem using tools provided to them by embodiments of the invention. Also, the business members of the ecosystem are given access to tools and information that enables them to create, deliver, and analyze the results from highly relevant and timely marketing impressions using tools provided to them by any embodiment of the invention.

More particularly, embodiments of the present invention describe a “business-to-consumer” (B2C) marketing and advertising method and ecosystem that obsoletes the current, corporate-controlled approach to consumer ‘mass-marketing’. This is achieved by implementing a novel method where consumer members have 100% control over marketing impressions received from a personally chosen subset of business subscribers in the ecosystem. Selected business subscribers are notified of consumer member interest in their marketing messages and have immediate use of the ecosystem's tools to deliver relevant, timely messages to these select consumer members. Message delivery is filtered through consumer preferences for timing, delivery method and quantity of messaging. The novel method of embodiments of the invention delivers rapid “viral expansion loop” population growth. Utility for consumer and business members grows with the total ecosystem population. Full control of marketing and advertising by consumers delivers higher customer satisfaction; more effective business marketing campaigns; massive reductions in the environmental impacts of paper, plastic, and chemicals used by traditional methods.

Systems and methods for consumer-controlled specification, filtering and delivery of personalized product service offers to “opted-in” consumers are thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

We claim:

1. A multimedia gateway for consumer-controlled delivery of product/service offers comprising:
a plurality of business subscribers;
a plurality of offers from said plurality of business subscribers, wherein each offer is associated with an offer category;
a consumer member;
a set of consumer preferences defined by said consumer member and stored in a consumer profile associated with said consumer member, wherein said set of preferences defines one or more offer categories preferred by said consumer member;
a set of business subscriber sponsors selected from said plurality of business subscribers by said consumer member;
a set of sponsored offers from said set of business subscriber sponsors;
an offer exchange for matching a sponsored offer from said set of sponsored offers with said consumer member based on said set of consumer preferences; and
a distribution server for distributing said sponsored offer to said consumer member.

2. The consumer gateway of claim 1, wherein an offer in said plurality of offers comprises a coupon for a product or service.

3. The consumer gateway of claim 1, further comprising:
a subscription manager for managing a consumer account of said consumer member; and
a consumer interface allowing said consumer member to modify said set of preferences.

4. The consumer gateway of claim 1, further comprising:
a master control that allows said consumer member to permit or restrict delivery of one or more sponsored offers from a business subscriber sponsor according to said set of preferences.

5. The consumer gateway of claim 1, wherein said distribution server allows said consumer member to define frequency and timing for delivery of sponsored offers from a business subscriber sponsor.

6. The consumer gateway of claim 1, wherein said distribution server allows said consumer member to define a total cap on the number of sponsored offers delivered over a period.

7. The consumer gateway of claim 1, wherein said set of consumer preferences directly defines a category preferred by said consumer member.

8. The consumer gateway of claim 1, wherein said set of consumer preferences indirectly defines a category preferred by said consumer member.

9. The consumer gateway of claim 1, wherein said distribution server delivers said sponsored offer in audio format to said consumer member.

10. The consumer gateway of claim 1, wherein said distribution server delivers said sponsored offer in a format preferred by said consumer member.

11. The system of claim 1, further comprising:
a forwarding module permitting said consumer member to forward said sponsored offer throughout a social network comprising said consumer member and friends of said consumer member.

12. The consumer gateway of claim 1, wherein said friends of said consumer member in said social network comprises other consumer members.

13. The consumer gateway of claim 1, wherein said offer exchange matches said sponsored offer to said consumer member by matching an offer category of said sponsored offer to said one or more offer categories preferred by said consumer member.

14. The consumer gateway of claim 1, wherein said set of consumer preferences further comprises:
a bid for a product or service, wherein said bid is associated with an offer category preferred by said consumer member; and
wherein said offer exchange matches said sponsored offer to said bid by offer category.

15. The consumer gateway of claim 1, wherein said set of consumer preferences further comprises:
a bid for a product or service, wherein said bid is associated with an offer category preferred by said consumer member; and
wherein said offer exchange further comprises:
a presenter for presenting said bid to said set of business subscriber sponsors having sponsored offers matching said offer category associated with said bid;
a matching engine for receiving at least one acceptance of said bid by business subscriber sponsors in said set, and wherein said distribution server delivers said at least one acceptance to said consumer member for consideration.

16. A system for consumer-controlled delivery of offers, comprising:
a plurality of business subscribers;
a plurality of consumer members;
a plurality of sets of consumer preferences, wherein each set of consumer preferences is defined by a corresponding consumer member and defines one or more offer categories preferred by said corresponding consumer member;
a plurality of user profiles of said plurality of consumer members, wherein each of said plurality of sets of preferences is stored in a corresponding user profile;
an advertising campaign of a business subscriber, wherein said advertising campaign comprises a sponsored offer associated with a corresponding offer category; and
an offer exchange for matching by category said sponsored offer with a target set of consumer members based on said plurality of sets of consumer preferences.

17. The system of claim 16, wherein said sponsored offer comprises a proposed sponsored offer, and wherein said system further comprises:
a delivery rate calculator for determining a total number of consumer members within said target set.

18. The system of claim 17, further comprising:
a conversion predictor for determining a conversion rate of said proposed sponsored offer within said target set of consumer members based on historical data of said consumer members in said target set stored in corresponding user profiles.

19. The system of claim 16, further comprising:
a distribution server for distributing said sponsored offer to consumer members in said target set of consumer members.

20. The system of claim 19, wherein said sponsored offer comprises a plurality of coupons for either a good or service, wherein each coupon comprises a unique identifier that uniquely identifies a coupon to a corresponding consumer member in said target set of consumer members, and wherein said system further comprises:
a tracker for tracking redemption of said plurality of coupons; and
a redemption rate calculator for determining a redemption rate for said plurality of coupons.

21. The system of claim 20, further comprising:
a subscription manager for managing said plurality of user profiles.

22. A method for consumer-controlled delivery of offers, comprising:
determining a set of consumer preferences as defined by a consumer member;
determining one or more offer categories preferred by said consumer member based on said set of preferences;
receiving a plurality of offers from a plurality of business subscribers, wherein each offer is associated with an offer category;
determining a set of business subscriber sponsors selected from said plurality of business subscribers by said consumer member;
reducing said plurality of offers by determining a set of sponsored offers that originate from said set of business subscriber sponsors;
reducing said set of sponsored offers by matching by category a sponsored offer from said set of sponsored offers with said consumer member based on said set of consumer preferences; and
distributing said sponsored offer to said consumer member over a communication network.

23. The method of claim 22, wherein said determining one or more offer categories comprises:
determining that said set of consumer preferences directly defines an offer category.

24. The method of claim 22, wherein said determining one or more offer categories comprises:
indirectly defining an offer category based on said set of consumer preferences.

25. The method of claim 22, further comprising:
storing said set of consumer preferences in a consumer profile of said consumer member.

26. The method of claim 22, wherein said determining a set of preferences comprises:
receiving at least one consumer preference defining frequency and timing of delivery of sponsored offers that are matched to said consumer member; and
wherein said distributing said sponsored offer comprises distributing said sponsored offer in compliance with said at least one preference defining frequency and timing.

27. The method of claim 22, further comprising:
receiving a suggestion to invite a business as a subscriber from said consumer member; and
delivering an invitation to said business to join as a subscriber.

28. The method of claim 22, wherein said distributing said sponsored offer further comprises:
formatting said sponsored offer and delivering said properly formatted sponsored offer to said consumer member over a communication network according to a corresponding consumer preference.

29. The method of claim 22, further comprising:
receiving instruction to forward said sponsored offer throughout a social network comprising said consumer member and friends of said consumer member including other consumer members; and
forwarding said sponsored offer throughout said social network.

30. The method of claim 22, wherein said distributing said sponsored offer further comprises:
determining that said sponsored offer matches a category of offers that is of interest to a group of consumer members, wherein said consumer member acts as a representative to said group of consumer members for said category of offers of interest to said group; and
distributing said sponsored offer to said group of parties.
